(19) United States
(12) Patent Application Publication
(10) Pub. No.: US 2025/0167893 A1
(43) Pub. Date: May 22, 2025

(54) OPTICAL NETWORK SYSTEM, CONTROL APPARATUS, OPTICAL RELAY APPARATUS, CONTROL METHOD, AND NON-TRANSITORY COMPUTER READABLE MEDIUM

(71) Applicant: NEC Corporation, Minato-ku, Tokyo (JP)

(72) Inventor: Hidemi NOGUCHI, Tokyo (JP)

(73) Assignee: NEC Corporation, Minato-ku, Tokyo (JP)

(21) Appl. No.: 18/839,749

(22) PCT Filed: Feb. 25, 2022
(86) PCT No.: PCT/JP2022/007988

§ 371 Date: Aug. 20, 2024

(51) Int. Cl. H04B 10/291; H04B 10/2525

(52) U.S. Cl. CPC H04B 10/291; H04B 10/2525

(57) ABSTRACT

An optical network system includes an optical relay apparatus (20) that forms an optical network and a control apparatus (10) that controls the optical relay apparatus (20), in which the control apparatus (10) includes: a management unit (11) configured to manage wavelength information of an optical signal transmitted and received by the optical relay apparatus (20) in a path of the optical network and transmission line information of an optical transmission line connected to the optical relay apparatus (20); and a compensation control unit (12) configured to determine a wavelength dispersion compensation amount compensated in the optical relay apparatus (20) based on the wavelength information and the transmission line information.

### TECHNICAL FIELD

The present invention relates to an optical network system, a control apparatus, an optical relay apparatus, a control method, and a non-transitory computer readable medium.

### BACKGROUND ART

In recent years, introduction of a 5G wireless communication system has been promoted, and towards the post-5G era, demands for further ultra-low delay and multiple simultaneous connection in addition to ultra-high speed in not only wireless communication but also optical communication fields have been intensified. For this reason, an optical communication system is expected to be utilized for various communication services and industrial applications, and research is being advanced.

For example, in a backbone optical communication system, a digital coherent method in which an optical phase modulation method and a polarization demultiplexing technique are combined is used, whereby a large capacity of more than 100 Giga bit per second (Gbps) is achieved. In addition, a transmission method also has been researched and developed in which a signal-band is narrowed and wavelength-multiplexed (Wavelength Division Multiplexing: WDM), thereby improving frequency utilization efficiency and enabling multiple simultaneous connection.

As related techniques, for example, Patent Literature 1-3 are known. Patent Literature 1 discloses a wavelength converter that converts a wavelength of an optical signal by a receiving end and a transmission end using a coherent method. Patent Literature 2 discloses connecting an optical phase conjugator that generates a phase conjugation signal by digital signal processing between a transmission apparatus and a reception apparatus. Patent Literature 3 discloses connecting a dispersion compensating module that compensates for wavelength dispersion in an optical transmission line between a transmission apparatus and a reception apparatus.

### CITATION LIST

### Patent Literature

[Patent Literature 1] Published Japanese Translation of PCT International Publication for Patent Application, No. 2017-511036
[Patent Literature 2] United States Patent Application Publication No. 2012/0224855
[Patent Literature 3] Japanese Unexamined Patent Application Publication No. 2011-035735

### SUMMARY OF INVENTION

### Technical Problem

However, in the related techniques such as Patent Literature 1-3, in an optical network system in which a network route (path) is switched depending on a situation, changes in characteristics or the like of an optical transmission line due to route switching are not taken into account. Therefore, there is a problem that the signal quality may be deteriorated due to the reason that an expected effect cannot be obtained or route switching cannot be dealt with.

The present disclosure has been made in view of the aforementioned problems, and an object of the present disclosure is to provide an optical network system, a control apparatus, an optical relay apparatus, a control method, and a non-transitory computer readable medium capable of suppressing deterioration of a signal quality even in an optical network system in which network routes are switched as appropriate.

### Solution to Problem

An optical network system according to the present disclosure includes an optical relay apparatus that forms an optical network and a control apparatus that controls the optical relay apparatus. The control apparatus includes: management means for managing wavelength information of an optical signal transmitted and received by the optical relay apparatus in a path of the optical network and transmission line information of an optical transmission line connected to the optical relay apparatus; and compensation control means for determining a wavelength dispersion compensation amount compensated in the optical relay apparatus based on the wavelength information and the transmission line information. The optical relay apparatus includes: acquisition means for acquiring the determined wavelength dispersion compensation amount from the control apparatus; and wavelength dispersion compensation means for performing, based on the acquired wavelength dispersion compensation amount, wavelength dispersion compensation processing on an electric signal which is based on an optical signal to be received.

A control apparatus according to the present disclosure includes: management means for managing wavelength information on an optical signal transmitted and received by an optical relay apparatus in a path of an optical network and transmission line information of an optical transmission line connected to the optical relay apparatus; and compensation control means for determining a wavelength dispersion compensation amount compensated in the optical relay apparatus based on the wavelength information and the transmission line information.

An optical relay apparatus according to the present disclosure includes: acquisition means for acquiring a wavelength dispersion compensation amount from a control apparatus: coherent optical reception front-end means for coherently detecting, based on local oscillation light, an optical signal to be received to output the coherently-detected electric signal: wavelength dispersion compensation means for performing, based on the acquired wavelength dispersion compensation amount, wavelength dispersion compensation processing on the electric signal by digital signal processing; and coherent optical transmission front-end means for coherently modulating, based on a transmission signal, the electric signal on which the wavelength dispersion compensation processing has been performed and transmitting the coherently-modulated optical signal.

A control method according to the present disclosure: manages wavelength information on an optical signal transmitted and received by an optical relay apparatus in a path of an optical network and transmission line information of an optical transmission line connected to the optical relay apparatus; and determines a wavelength dispersion compensation amount compensated in the optical relay apparatus based on the wavelength information and the transmission line information.

A non-transitory computer readable medium storing a control program according to the present disclosure is a non-transitory computer readable medium storing a control program for causing a computer to execute processing of: managing wavelength information on an optical signal transmitted and received by an optical relay apparatus in a path of an optical network and transmission line information of an optical transmission line connected to the optical relay apparatus; and determining a wavelength dispersion compensation amount compensated in the optical relay apparatus based on the wavelength information and the transmission line information.

### Advantageous Effects of Invention

According to the present disclosure, it is possible to provide an optical network system, a control apparatus, an optical relay apparatus, a control method, and a non-transitory computer readable medium capable of suppressing deterioration of a signal quality even in an optical network system where network routes are switched as appropriate.

### BRIEF DESCRIPTION OF DRAWINGS

FIG. 1 is a configuration diagram showing a configuration example of an optical network system according to a basic example;

FIG. 2 is a configuration diagram showing a configuration example of an optical relay apparatus according to the basic example:

FIG. 3 is a configuration diagram showing a configuration of an optical transceiver according to a first examined example:

FIG. 4 is a diagram for describing a problem in the optical transceiver according to the first examined example:

FIG. 5 is a diagram for describing a problem in the optical transceiver according to the first examined example:

FIG. 6 is a diagram for describing a configuration and a problem of an optical transceiver according to a second examined example:

FIG. 7 is a configuration diagram showing a configuration of an optical transceiver according to a third examined example:

FIG. 8A is a diagram for describing a problem in the optical transceiver according to the third examined example:

FIG. 8B is a diagram for describing a problem in the optical transceiver according to the third examined example:

FIG. 9 is a graph showing wavelength dispersion characteristics of wavelength-wavelength dispersion:

FIG. 10 is a configuration diagram showing a configuration of an outline of a control apparatus according to the example embodiment:

FIG. 11 is a configuration diagram showing a configuration of an outline of an optical relay apparatus according to the example embodiment:

FIG. 12 is a configuration diagram showing a configuration of the outline of the optical relay apparatus according to the example embodiment:

FIG. 13 is a configuration diagram showing a configuration example of an optical network system according to a first example embodiment:

FIG. 14 shows a configuration showing a configuration example of each of apparatuses in the optical network system according to the first example embodiment;

FIG. 15 is a configuration diagram showing a configuration example of a wavelength dispersion compensation unit according to the first example embodiment;

FIG. 16 is a configuration diagram showing a configuration example of the wavelength dispersion compensation unit according to the first example embodiment:

FIG. 17 is a flowchart showing an operation example of the optical network system according to the first example embodiment;

FIG. 18A is a diagram showing a specific example of wavelength dispersion compensation by a control method according to the first example embodiment;

FIG. 18B is a diagram showing a specific example of the wavelength dispersion compensation by the control method according to the first example embodiment;

FIG. 19A is a diagram showing another specific example of the wavelength dispersion compensation by the control method according to the first example embodiment;

FIG. 19B is a diagram showing another specific example of the wavelength dispersion compensation by the control method according to the first example embodiment;

FIG. 20A is a diagram showing a specific example of wavelength dispersion compensation by a control method according to a second example embodiment;

FIG. 20B is a diagram showing a specific example of the wavelength dispersion compensation by the control method according to the second example embodiment;

FIG. 21A is a diagram showing another specific example of the wavelength dispersion compensation by the control method according to the second example embodiment;

FIG. 21B is a diagram showing another specific example of the wavelength dispersion compensation by the control method according to the second example embodiment;

FIG. 22 is a configuration diagram showing a configuration example of an optical network system according to a third example embodiment;

FIG. 23 is a flowchart showing an operation example of the optical network system according to the third example embodiment;

FIG. 24A is a diagram showing a specific example of wavelength dispersion compensation by a control method according to the third example embodiment;

FIG. 24B is a diagram showing a specific example of the wavelength dispersion compensation by the control method according to the third example embodiment;

FIG. 25 is a configuration diagram showing a configuration example of an optical network system according to a fourth example embodiment;

FIG. 26 is a flowchart showing an operation example of the optical network system according to the fourth example embodiment;

FIG. 27A is a diagram showing a specific example of wavelength dispersion compensation by a control method according to the fourth example embodiment;

FIG. 27B is a diagram showing a specific example of the wavelength dispersion compensation by the control method according to the fourth example embodiment;

FIG. 28A is a diagram showing a specific example of wavelength dispersion compensation by a control method according to other example embodiments;

FIG. 28B is a diagram showing a specific example of the wavelength dispersion compensation by the control method according to the other example embodiments;

FIG. 29A is a diagram showing a specific example of the wavelength dispersion compensation by the control method according to the other example embodiments;

FIG. 29B is a diagram showing a specific example of the wavelength dispersion compensation by the control method according to the other example embodiments;

FIG. 30A is a diagram showing a specific example of the wavelength dispersion compensation by the control method according to the other example embodiments;

FIG. 30B is a diagram showing a specific example of the wavelength dispersion compensation by the control method according to the other example embodiments;

FIG. 31 is a configuration diagram showing a configuration example of an optical relay apparatus according to the other example embodiments;

FIG. 32 is a configuration diagram showing a configuration example of the optical relay apparatus according to the other example embodiments; and

FIG. 33 is a configuration diagram showing an outline of hardware of a computer according to the example embodiment.

### EXAMPLE EMBODIMENT

Hereinafter, example embodiments will be explained with reference to the drawings. In the drawings, the same elements are denoted by the same reference numerals, and redundant explanations are omitted as necessary. Note that arrows attached in configuration diagrams (block diagrams) are examples for explanation, and do not limit types or directions of signals.

### (Study Leading to Example Embodiments)

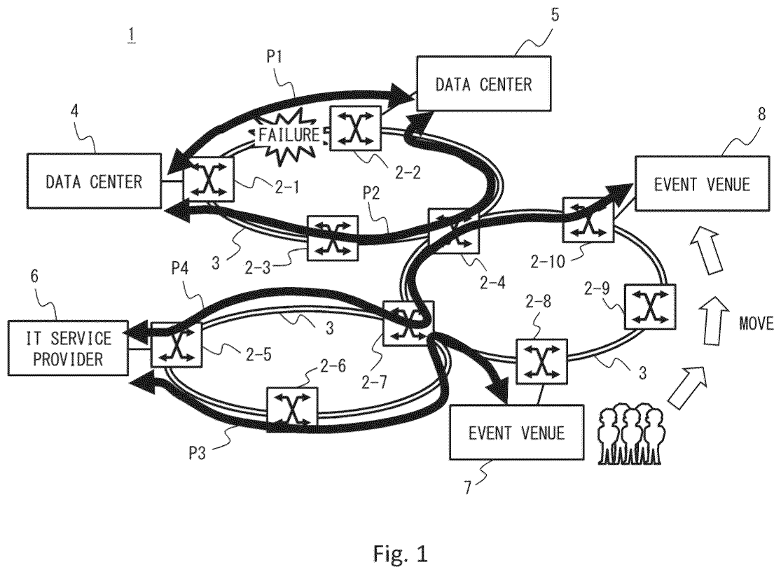

FIG. 1 shows a configuration of an optical network system according to a basic example, which forms a basis of example embodiments. An optical network system 1 according to the basic example is, for example, a backbone wavelength multiplexing optical transmission system, and performs high-capacity communication exceeding 100 Gbps by performing high multi-level modulation and performing digital coherent transmission on optical signals of wavelengths. By high-density wavelength multiplexing, it is possible to improve frequency utilization efficiency of light, and it is possible to support mobile traffic and wavelength defragmentation. In addition, since a transmission route (wavelength path) can be flexibly switched as an optical signal by wavelength multiplexing, by switching the transmission route in an event of a failure, it is possible to avoid the failure and to maintain the infrastructure. Further, in the basic example, real-time performance is improved toward the post-5G era, and it is possible to cope with an ultra-low latency.

As shown in FIG. 1, the optical network system 1 according to the basic example includes a plurality of optical relay apparatuses 2 (for example, 2-1 to 2-10) that are connected to each other via an optical transmission line (optical fiber transmission line) 3 in such a way that they can perform optical communication. The optical relay apparatus 2 is a photonic node capable of relaying a wavelength-multiplexed optical signal, and is, for example, a Reconfigurable Optical Add/Drop Multiplexer (ROADM) device.

A wavelength path (it may be simply referred to as a path) is allocated to each optical relay apparatus 2, and a local network to be accommodated or traffic of another optical relay apparatus 2 is transferred via the allocated wavelength path. For example, the optical relay apparatus 2-1 accommodates a network of a data center 4, and the optical relay apparatus 2-2 accommodates a network of a data center 5, and large-capacity traffic such as a video distribution service that distributes high-quality video (4k/8k) is transferred. When a failure occurs in a wavelength path P1 while the optical relay apparatus 2-1 and the optical relay apparatus 2-2 are transferring traffic between the data center 4 and the data center 5 via the wavelength path P1, the wavelength path P1 is switched to a wavelength path P2. As a result, it is possible to maintain the transfer of traffic between the data center 4 and the data center 5 via a detour route including the optical relay apparatus 2-3 and the optical relay apparatus 2-4.

For example, the optical relay apparatus 2-5 accommodates an IoT sensor network of an IT service provider 6, and the optical relay apparatus 2-8 accommodates a mobile network of an event venue 7. Traffic of the mobile network is traffic of spot demand by moving users. When a user of the event venue 7 moves to an event venue 8 while the optical relay apparatus 2-5 and the optical relay apparatus 2-8 are transferring traffic between the IT service provider 6 and the event venue 7 via a wavelength path P3 including the optical relay apparatus 2-6 and the optical relay apparatus 2-7, the wavelength path P3 is switched to a wavelength path P4. Accordingly, it is possible to maintain the transfer of the traffic of the user who has moved to the event venue 8 via the optical relay apparatus 2-6, the optical relay apparatus 2-4, and the optical relay apparatus 2-10.

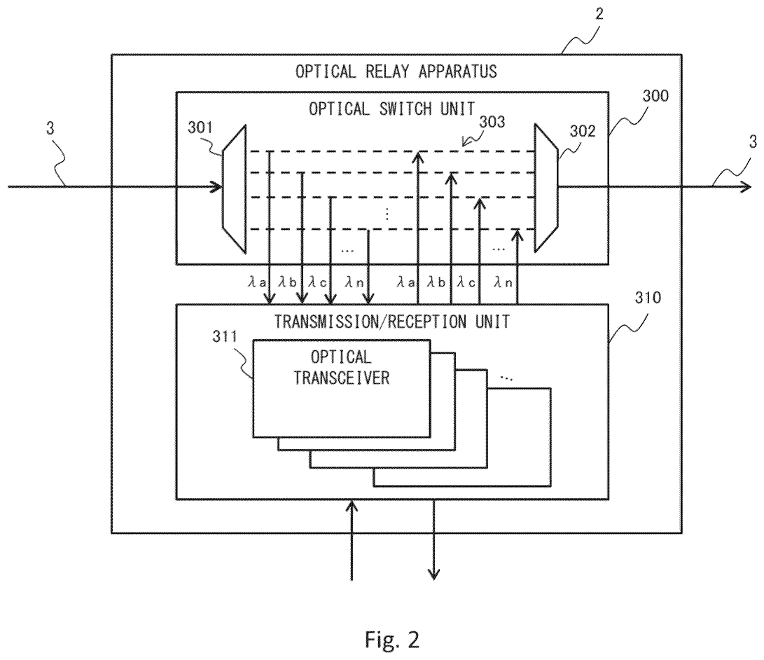

FIG. 2 shows a configuration example of the optical relay apparatus 2 according to the basic example. The optical relay apparatus 2 branches/inserts a wavelength multiplexed signal, and coherently modulates and demodulates a signal of each wavelength to be branched/inserted. As described in FIG. 2, the optical relay apparatus 2 includes an optical switch unit 300 and a transmission/reception unit 310.

The optical switch unit 300 transfers an optical signal of a predetermined wavelength path to be received from the optical relay apparatus 2 of the preceding stage to the optical relay apparatus 2 of a subsequent stage in the optical network system 1, and branches/inserts the optical signal to be received for each wavelength. For example, the optical switch unit 300 includes a demultiplexer 301, a multiplexer 302, and a branch insertion unit 303. The demultiplexer 301 separates the optical signal received from the optical transmission line 3 into optical signals of a plurality of wavelengths. The multiplexer 302 multiplexes optical signals of a plurality of wavelengths into one optical signal and transmits the optical signal to the optical transmission line 3. The branch insertion unit 303 branches/inserts optical signals of the respective wavelengths between the demultiplexer 301 and the multiplexer 302.

The transmission/reception unit (transponder) 310 receives the optical signal of each wavelength branched from the branch insertion unit 303 of the optical switch unit 300, outputs reception data that have been coherently demodulated to a local apparatus (network), receives transmission data from the local apparatus, and transmits (inserts) the optical signal of each wavelength that has been coherently modulated to the branch insertion unit 303 of the optical switch unit 300. The transmission/reception unit 310 includes a plurality of optical transceivers 311 that transmit and receive optical signals of the respective wavelengths. The optical transceiver 311 receives an optical signal of a predetermined wavelength, and further transmits an optical signal of a predetermined wavelength (a wavelength that is the same as or different from a reception wavelength).

Here, problems that occurs when optical transceivers according to first to third examined examples are used as the optical transceiver 311 will be discussed.

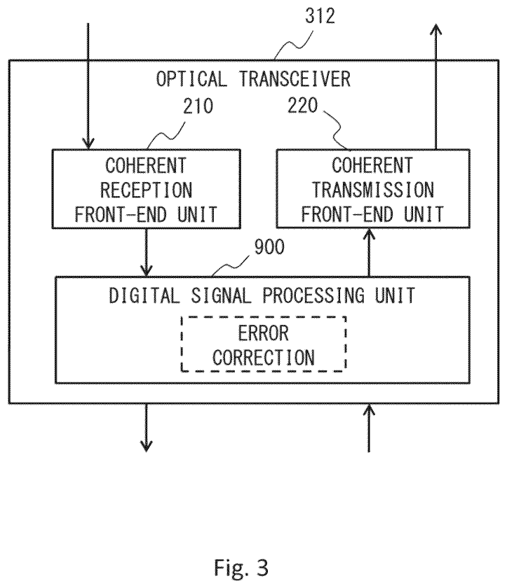

FIG. 3 shows a configuration example of an optical transceiver according to the first examined example. As shown in FIG. 3, an optical transceiver 312 according to the first examined example includes a coherent reception front-end unit 210, a coherent transmission front-end unit 220, and a digital signal processing unit 900.

The coherent reception front-end unit 210 coherently detects an optical signal received from an optical relay apparatus 2 of a preceding stage by Local oscillator (LO) light of a predetermined wavelength, and outputs the detected signal to the digital signal processing unit 900. The coherent transmission front-end unit 220 performs optical modulation (coherent modulation) on the signal processed by the digital signal processing unit 900, and transmits the generated optical signal to an optical relay apparatus 2 of a next stage. The digital signal processing unit 900 is a Digital Signal Processor (DSP), converts a signal coherently detected by the coherent reception front-end unit 210 into a digital signal, outputs the decoded reception data, encodes the input transmission data, and outputs the converted signal for optical modulation to the coherent transmission front-end unit 220. In the first examined example, the digital signal processing unit 900 performs decoding, error correction, or the like to reproduce data.

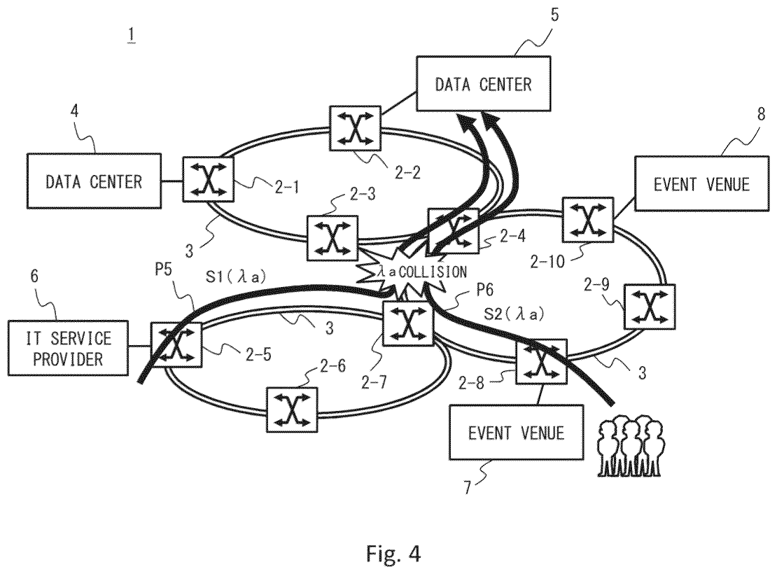

A case where optical signals of the same wavelength collide with each other, as shown in FIG. 4, when an optical relay apparatus 2 which uses the optical transceiver 312 according to the first examined example relays an optical signal, will be considered. Assume a case, for example, where a wavelength path P6 is set between an optical relay apparatus 2-2 and an optical relay apparatus 2-8, and traffic is transferred between an event venue 7 and a data center 5 in a case where a wavelength path P5 is set between the optical relay apparatus 2-2 and an optical relay apparatus 2-5 and traffic is transferred between an IT service provider 6 and the data center 5. At this time, when wavelength slots of the wavelength path P5 and the wavelength path P6 are a, an optical signal S1 of the wavelength path P5 and an optical signal S2 of the wavelength path P6 collide with each other in an optical relay apparatus 2-7.

In the above case, a method of avoiding the collision by switching the wavelength path P5 or the wavelength path P6 to another route is also conceivable, but a wavelength slot of another route is not always empty. Even supposing that the path is switched, there is a possibility that latency increases due to the detour path. In the optical switch of the optical relay apparatus, a method of collectively switching a certain wavelength band including optical signals of a plurality of channels into another wavelength band as an optical signal by using a wavelength conversion device or the like by optical elements is also conceivable, but in this case, it is impossible to switch it in a signal channel unit.

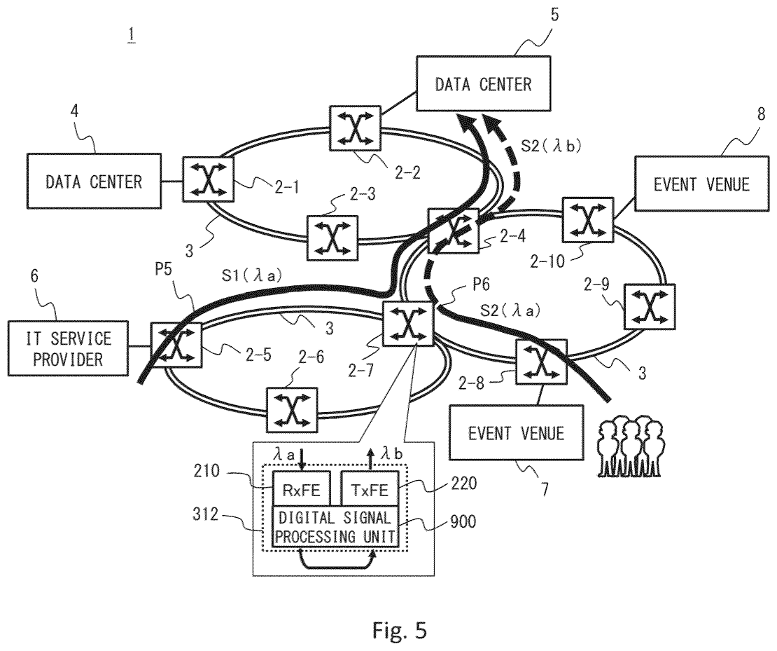

In order to solve the above problem, as shown in FIG. 5, a method of converting an optical signal into an empty wavelength slot in the optical relay apparatus 2-7 in which a collision occurs is conceivable. For example, in the optical transceiver 312 of the optical relay apparatus 2-7, the wavelength of the optical signal in the wavelength path P6 is converted from λ1 to λ2. Thus, since the wavelengths of the optical signal S1 of the wavelength path P5 and the optical signal S2 of the wavelength path P6 are different in a route from the optical relay apparatus 2-7 to the optical relay apparatus 2-2, a collision can be avoided.

However, in the case of FIG. 5, there is a problem that latency increases because reproduction relay is performed when the optical transceiver 312 performs the wavelength conversion and turns around the optical signal. Namely, since the digital signal processing unit 900 of the optical transceiver 312 performs complicated digital signal processing and error correction processing, the latency becomes large. In addition, a circuit size for digital signal processing is large, and power consumption is also large.

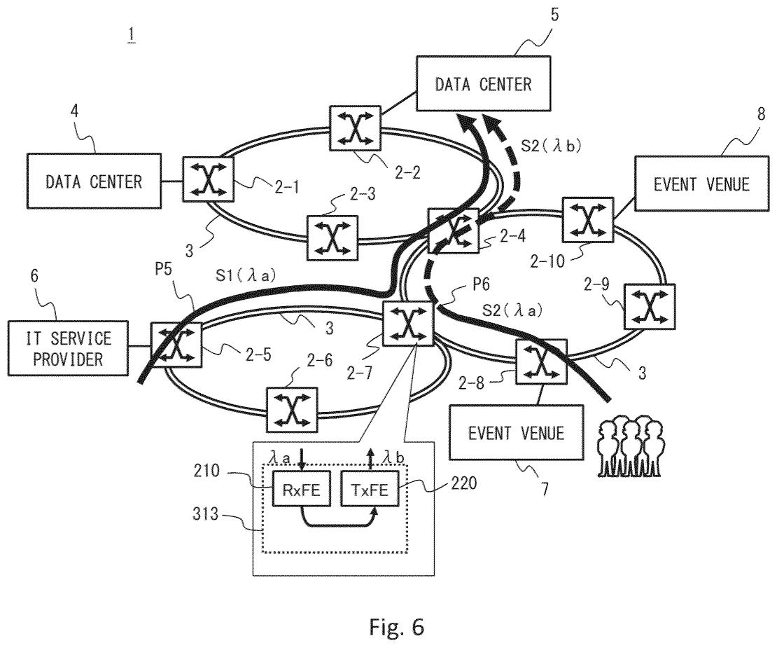

In order to solve the above problem, a second examined example which is based on the disclosure in Patent Literature 1 may be considered. In the second examined example, in an optical transceiver, an optical signal is turned around without using a digital signal processing unit of an optical transceiver. FIG. 6 shows an example in which an optical transceiver 313 according to the second examined example is applied to the network shown in FIG. 5.

As shown in FIG. 6, in the second examined example, in an optical transceiver 313, an analog signal output from a coherent reception front-end unit 210 is turned around and relayed to a coherent transmission front-end unit 220 without passing through digital signal processing. That is, in the second examined example, wavelength conversion is performed by performing optical-electricity (analog)-optical conversion without passing through digital signal processing which involves a complicated and large delay. Accordingly, a reduction in size and power saving can be performed, and an increase in latency which is due to complicated digital signal processing can be suppressed.

However, in the second examined example, there is a problem that the signal quality may be deteriorated since the waveform distortion or the like of the optical signal that occurs when the optical signal passes through a plurality of optical relay apparatuses (optical transceiver circuits) and the optical fiber transmission line is not taken into consideration.

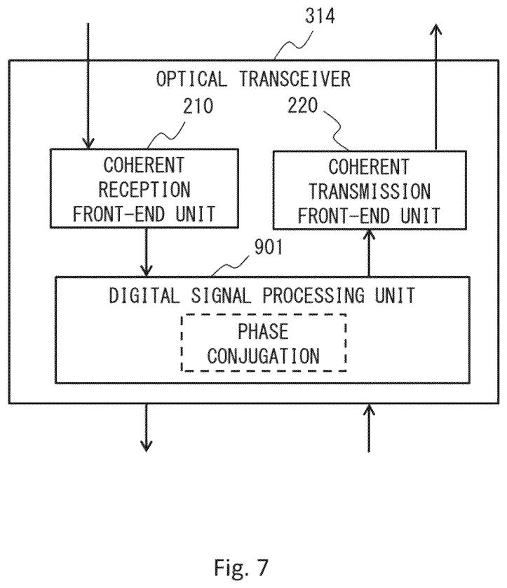

Now, a third examined example which is based on the disclosure of Patent Literature 2 may be considered. In the third examined example, wavelength dispersion compensation can be performed by performing phase conjugation processing by digital processing in an optical transceiver. FIG. 7 shows a configuration example of an optical transceiver according to the third examined example.

As shown in FIG. 7, an optical transceiver 314 according to the third examined example includes a coherent reception front-end unit 210, a coherent transmission front-end unit 220, and a digital signal processing unit 901.

In the third examined example, unlike the first examined example, in the digital signal processing unit 901, data reproduction such as error correction is not performed, and only phase conjugation processing on a digital signal is performed. Accordingly, deterioration and the like of the signal quality due to wavelength dispersion may be suppressed while suppressing an increase in latency which is due to complicated error correction processing or the like.

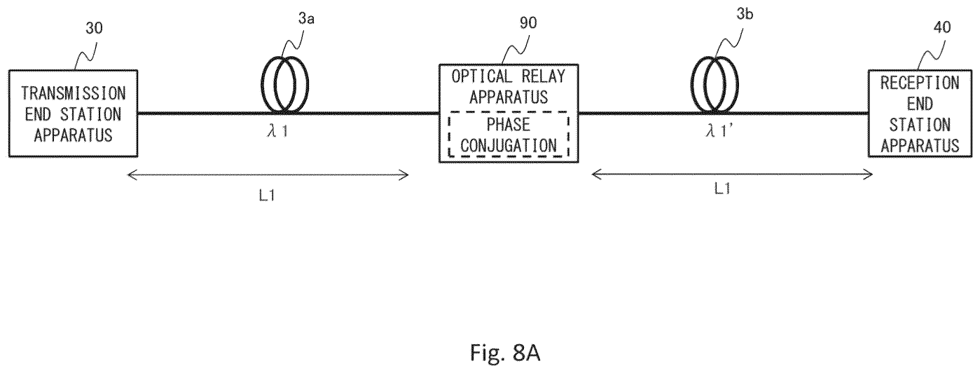

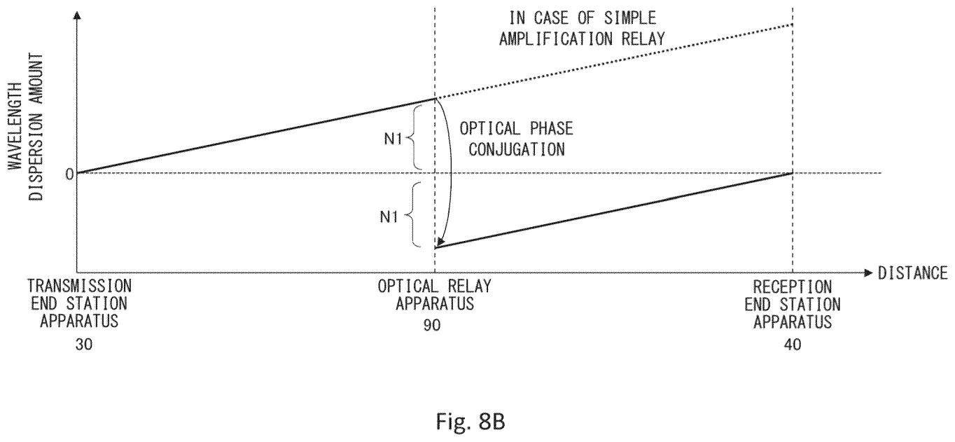

FIGS. 8A and 8B each show a wavelength dispersion amount in a case where an optical relay apparatus 90 including the optical transceiver 314 according to the third examined example is used. As shown in FIG. 8A, the optical relay apparatus 90 is connected between a transmission end station apparatus (transmission end) 30 and a reception end station apparatus (receiving end) 40 via optical transmission lines 3a and 3b. In the third examined example, it is assumed that the optical transmission line 3a and the optical transmission line 3b have the same distance (i.e., length). An optical signal of a wavelength λ1 is transmitted in the optical transmission line 3a, and an optical signal having a wavelength λ1′ close to the wavelength λ1 is transmitted in the optical transmission line 3b.

Note that, in the configuration as shown in FIG. 8A in which the optical relay apparatus is connected to a path from the transmission end station apparatus to the reception end station apparatus, a side closer to the transmission end station apparatus with respect to the optical relay apparatus may be referred to as a front side of the optical relay apparatus (reception side of the optical signal), and a side closer to the reception end station apparatus with respect to the optical relay apparatus may be referred to as a rear side of the optical relay apparatus (transmission side of the optical signal). Further, the optical transmission line between the optical relay apparatus and the transmission end station apparatus may be referred to as an optical transmission line of a first half (a first part), and the optical transmission line between the optical relay apparatus and the reception end station apparatus may be referred to as an optical transmission line of a latter half (a second part).

As shown in FIG. 8B, the wavelength dispersion amount increases in proportion to the distance of the optical transmission line. Therefore, when the optical relay apparatus has relayed the optical signal by signal amplification alone, the wavelength dispersion amount continues to increase in accordance with the distance from the transmission end station apparatus 30 to the reception end station apparatus 40. Then, the greater the distance of the optical transmission line is, the more greatly the quality of the optical signal received in the reception end station apparatus 40 is deteriorated.

In the third examined example, the optical relay apparatus 90 is arranged at a central point of the total transmission distance to perform optical phase conjugation. By performing phase conjugation processing on the optical signal in the optical relay apparatus 90, a wavelength dispersion (N1) accumulated in the optical transmission line 3a at the first half of the path is inverted to the wavelength dispersion (N1) on the negative side of the same dispersion amount. Accordingly, the influence of waveform distortion received in the optical transmission line 3b of the latter half of the path is canceled out since it receives an influence opposite to the influence of waveform distortion received in the optical transmission line 3a of the first half of the path, whereby the wavelength dispersion amount becomes zero in the reception end station apparatus 40. It is therefore possible to reduce the influence of the wavelength dispersion and Self Phase Moduration (SPM) non-linearity.

Further, as the third examined example, it may be possible to conceive of a method for further converting the wavelength frequency in order to suppress the influence of non-linearity in the optical relay apparatus based on the disclosure of Patent Literature 2. That is, a method for mapping, when a plurality of wavelengths are relayed by a plurality of transceivers of the optical relay apparatus, for a plurality of signal channels in which carrier frequencies are successive, carrier frequencies in the reverse order, and performing wavelength conversion, thereby reducing the influence of Cross Phase Moduration (XPM) non-linearity.

However, as a result of studying the third examined example, the inventors have found the following problem. That is, in the third examined example, Point-to-Point WDM transmission is assumed, and in order to obtain the aforementioned effect, it is assumed that the optical transmission line of the first half and the optical transmission line of the latter half are about the same, and that wavelength conversion is performed at a nearby carrier frequency (wavelength).

However, in a system in which wavelength collision is avoided, including route switching in the optical network as shown in FIG. 1 and the like, the distance of the optical transmission line before the optical relay apparatus in the transmission route is not always about the same as the distance of the optical transmission line after the optical relay apparatus in the transmission route. It is possible that the distance of the optical transmission line of the first half and that of the optical transmission line of the latter half may greatly differ from each other and thus the optical transmission line of the first half and the optical transmission line of the latter half may be asymmetric with each other. Therefore, it is possible that the effect of canceling out waveform distortion due to wavelength dispersion and fiber non-linearity occurring in the optical transmission lines before and after the optical relay apparatus may not be sufficiently obtained.

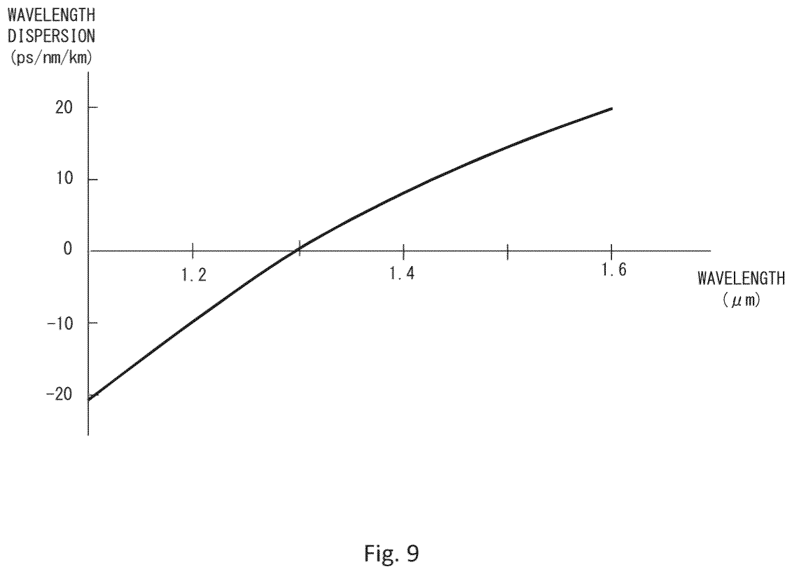

Further, FIG. 9 shows wavelength dispersion characteristics of wavelength-wavelength dispersion. As shown in FIG. 9, the wavelength dispersion characteristics vary depending on the wavelength (frequency), and the greater the distance between wavelengths of two optical signals, the greater the difference in the wavelength dispersion characteristics of the two optical signals. For example, in order to avoid wavelength collision in the optical network, it is assumed that wavelength conversion may be performed between a C-band (1528-1565 nm) and an L-band (1570-1605 nm). In particular, C-band/L-band mutual wavelength conversion has been required in accordance with an increase in capacity, and further conversion to another wavelength band may be performed in the future. Then, when wavelength conversion is performed by the optical relay apparatus, the carrier frequency before the conversion and the carrier frequency after the conversion are greatly different from each other, which causes a dramatic change in the wavelength dispersion characteristics. Therefore, even when the distance of the optical transmission line before the relay apparatus and that after the relay apparatus are about the same, a sufficient effect of reducing waveform distortion cannot be expected since the influence of the wavelength dispersion may greatly vary.

Therefore, in the third examined example, the relay by optical phase conjugation alone is not enough to sufficiently suppress and alleviate the influence of waveform distortion that occurs in the optical transmission line. Therefore, in this example embodiment, even when an optical transmission line in which the configuration before the optical relay apparatus and the configuration after the optical relay apparatus are asymmetric with each other is used or even in a case in which C-band/L-band mutual wavelength conversion is performed, it is possible to reduce the influence of wavelength dispersion and fiber non-linearity of the optical transmission line.

### Outline of Example Embodiments

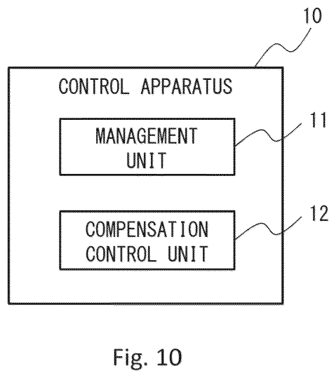

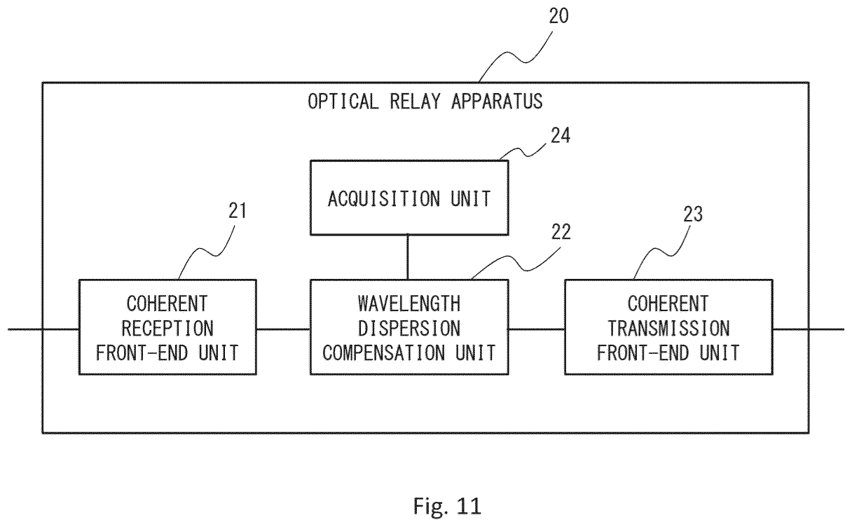

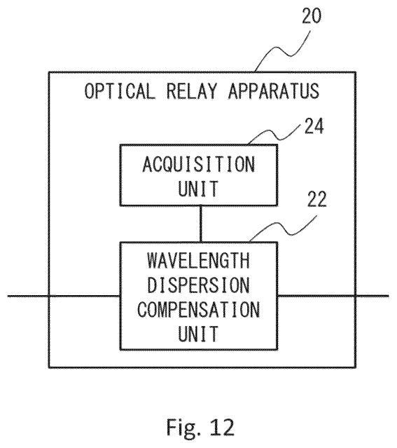

FIG. 10 shows a configuration of an outline of a control apparatus according to example embodiments and FIGS. 11 and 12 each show the configuration of the outline of the optical relay apparatus according to the example embodiments. An optical relay apparatus 20 according to the example embodiments forms an optical network and a control apparatus 10 according to the example embodiments controls the optical relay apparatus 20 in the optical network. The control apparatus 10 and the optical relay apparatus 20 constitute an optical network system.

As shown in FIG. 10, the control apparatus 10 includes a management unit 11 and a compensation control unit 12. The management unit 11 manages wavelength information of an optical signal transmitted and received by the optical relay apparatus 20 in a path of the optical network and transmission line information of an optical transmission line connected to the optical relay apparatus 20. The compensation control unit 12 determines a wavelength dispersion compensation amount compensated by the optical relay apparatus 20 based on the wavelength information and the transmission line information managed by the management unit 11.

As shown in FIG. 11, the optical relay apparatus 20 includes a coherent reception front-end unit 21, a wavelength dispersion compensation unit 22, a coherent transmission front-end unit 23, and an acquisition unit 24. Further, as shown in FIG. 12, the optical relay apparatus 20 may include a wavelength dispersion compensation unit 22 and an acquisition unit 24.

The acquisition unit 24 acquires the wavelength dispersion compensation amount determined by the compensation control unit 12 from the control apparatus 10. The coherent reception front-end unit 21 coherently detects the received optical signal based on a local oscillation light and outputs the coherently-detected electric signal. The wavelength dispersion compensation unit 22 performs wavelength dispersion compensation processing on the electric signal output from the coherent reception front-end unit 21 by digital signal processing based on the wavelength dispersion compensation amount acquired by the acquisition unit 24. The coherent transmission front-end unit 23 coherently modulates the electric signal that has been subjected to the wavelength dispersion compensation processing by the wavelength dispersion compensation unit 22 based on a transmission signal, and transmits the coherently-modulated optical signal.

As described above, in the example embodiments, the control apparatus determines, based on the wavelength information of the optical signal transmitted and received by the optical relay apparatus in the path and transmission line information of an optical transmission line connected to the optical relay apparatus, the wavelength dispersion compensation amount in the optical relay apparatus, and the optical relay apparatus performs wavelength dispersion compensation by the determined compensation amount. Accordingly, the optical relay apparatus can perform wavelength dispersion compensation with an appropriate compensation amount, whereby it is possible to efficiently suppress deterioration of the signal quality.

### First Example Embodiment

Next, with reference to the drawings, a first example embodiment will be described.

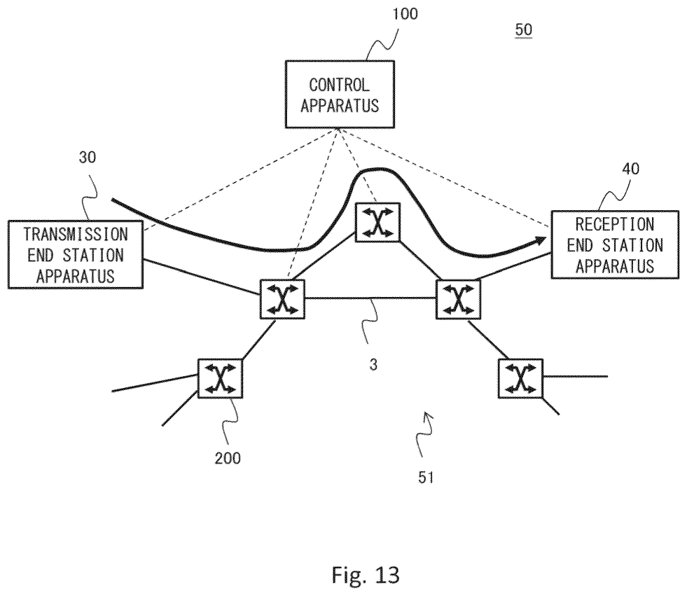

FIG. 13 shows a configuration example of an optical network system according to this example embodiment. As shown in FIG. 13, an optical network system 50 according to this example embodiment includes a control apparatus 100, a plurality of optical relay apparatuses 200, a transmission end station apparatus 30, and a reception end station apparatus 40.

The plurality of optical relay apparatuses 200, the transmission end station apparatus 30, and the reception end station apparatus 40 are connected to one another via an optical transmission line 3 in such a way that they can optically communicate with one another. The plurality of optical relay apparatuses 200, the transmission end station apparatus 30, the reception end station apparatus 40, and the control apparatus 100 are connected to one another in such a way that they can communicate control signals. The plurality of optical relay apparatuses 200, the transmission end station apparatus 30, the reception end station apparatus 40, and the control apparatus 100 may be connected to one another via the optical transmission line 3 or may be connected to one another by any other wired or wireless transmission lines in such a way that they can communicate with one another.

The plurality of optical relay apparatuses 200, the transmission end station apparatus 30, and the reception end station apparatus 40 are optical transmission apparatuses (optical nodes) that perform optical transmission via the optical transmission line 3. The transmission end station apparatus 30 and the reception end station apparatus 40 configure a transmission end and a receiving end in a path. The transmission end station apparatus 30 transmits an optical signal wavelength-multiplexed by the wavelength of the path set by the control apparatus 100 to the reception end station apparatus 40 via the optical transmission line 3. The reception end station apparatus 40 receives the optical signal wavelength-multiplexed by the wavelength of the path set by the control apparatus 100 from the transmission end station apparatus 30 via the optical transmission line 3.

The plurality of optical relay apparatuses 200 are relay apparatuses capable of relaying the wavelength-multiplexed optical signal, like in the basic example. The plurality of optical relay apparatuses 200 form an optical network 51 that performs WDM communication. It can be also said that the plurality of optical relay apparatuses 200 form the optical network 51 along with the transmission end station apparatus 30 and the reception end station apparatus 40. Like in FIG. 1, the optical network 51 is a wavelength multiplexing optical network. The optical network 51 may be a network in a form of a mesh, a network in a form of a ring, a Point-to-Point network, or a network of other topology. Further, the plurality of optical relay apparatuses 200 form a path from the transmission end station apparatus 30 to the reception end station apparatus 40 in accordance with control from the control apparatus 100, and transmits optical signals (data) by the wavelength set on the route of the path.

The control apparatus 100 manages and controls the optical network 51 including the plurality of optical relay apparatuses 200. The control apparatus 100 is, for example, a Network Management System (NMS) that manages a network.

The control apparatus 100 manages and controls the path formed of the optical relay apparatus 200 in the optical network 51. The control apparatus 100 manages the route and the wavelength of the path from the transmission end station apparatus 30 to the reception end station apparatus 40 and sets the route, the wavelength and the like of the path for the transmission end station apparatus 30, the reception end station apparatus 40, and the optical relay apparatuses 200 on the path.

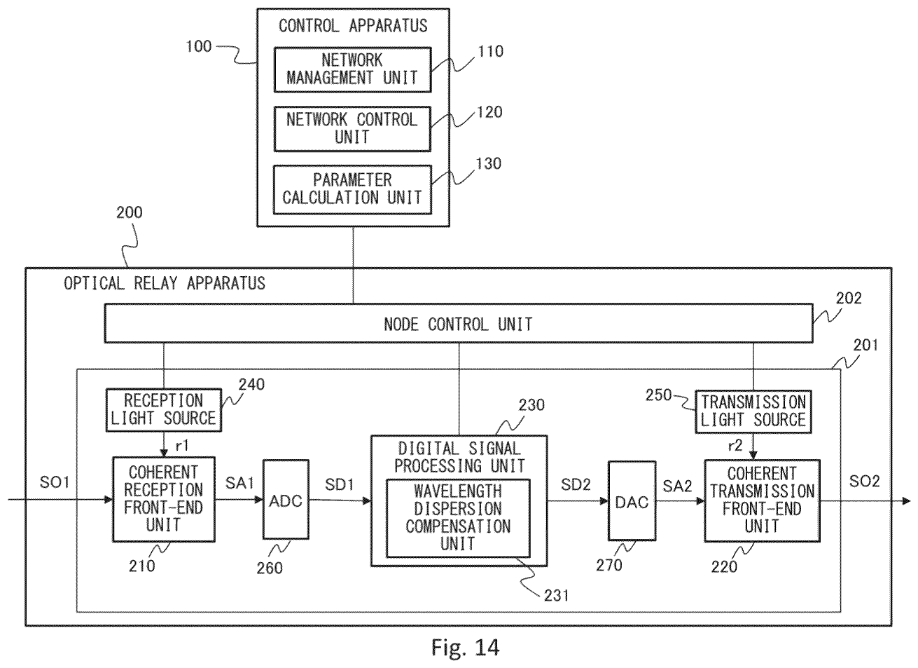

FIG. 14 shows a configuration example of each of the apparatuses in the 5 optical network system according to this example embodiment. As shown in FIG. 14, the control apparatus 100 includes a network management unit 110, a network control unit 120, and a parameter calculation unit 130.

The network management unit 110 manages information that is necessary for network management such as network configuration information or path configuration information in the optical network 51. For example, the network management unit 110 may be formed of a database that stores information that is necessary for network management. The network configuration information includes a connection relationship among the optical relay apparatuses 200, the transmission end station apparatus 30, and the reception end station apparatus 40 that form the network, and transmission line information of the optical transmission line 3 that connects the respective apparatuses. The transmission line information includes a distance (line length) of the optical transmission line, or may include the structure and the type of an optical fiber, transmission characteristics or the like. The path configuration information includes information on each of the apparatuses that form the path, wavelengths that can be used by each of the apparatuses on the route of the path, the usage status of the wavelengths, and the like. These information items may be set in a database in advance, may be set by information collected from each of the apparatuses, and may be updated by the network control unit 120 or the like.

The network control unit 120 controls the path in the optical network 51, and the optical relay apparatus 200, the transmission end station apparatus 30, and the reception end station apparatus 40 that form the path. The network control unit 120 refers to the network configuration information, the path configuration information and the like in the network management unit 110, determines the route and the wavelengths of the path from the transmission end station apparatus 30 to the reception end station apparatus 40, and sets the route and the wavelengths that have been determined in the transmission end station apparatus 30, the reception end station apparatus 40, and the optical relay apparatuses 200 on the route of the path. The wavelength of the path is determined for each optical transmission line in the route of the path. When, for example, the route of the path overlaps a route of another path, different wavelengths are selected between the paths from among the available wavelengths in the optical transmission line in the overlapping section. Further, the network control unit 120 outputs information required to calculate the wavelength dispersion compensation amount in the optical relay apparatus 200 that configures the path to the parameter calculation unit 130. For example, the network control unit 120 outputs the reception wavelength information of the optical relay apparatus 200 (the wavelength information of the optical signal to be received), the transmission wavelength information (the wavelength information of the optical signal to be transmitted), and the transmission line information of the optical transmission lines before and after the optical relay apparatus 200.

The parameter calculation unit 130 calculates parameters for controlling the optical relay apparatuses 200 that form the path. In this example, the parameter calculation unit 130 calculates the wavelength dispersion compensation amount for enabling the optical relay apparatus 200 to perform wavelength dispersion compensation. The parameter calculation unit 130 is a compensation control unit that determines the wavelength dispersion compensation amount of the optical relay apparatus 200 and controls the same. The parameter calculation unit 130 determines the optimal wavelength dispersion compensation amount for the optical relay apparatus 200 based on the reception wavelength information on the optical relay apparatus 200, the transmission wavelength information on the optical relay apparatus 200, and the transmission line information before and after the optical relay apparatuses 200, all of which being obtained from the network control unit 120. The parameter calculation unit 130 sends the reception wavelength information, the transmission wavelength information, and the optimal wavelength dispersion compensation amount of the optical relay apparatus 200 to the corresponding optical relay apparatus 200.

Further, as shown in FIG. 14, the optical relay apparatus 200 according to this example embodiment includes an optical transceiver 201 and a node control unit 202. While not shown in FIG. 14, like in the basic example shown in FIG. 2, the optical relay apparatus 200 includes an optical switch unit 300 and a transmission/reception unit 310, and the transmission/reception unit 310 includes a plurality of optical transceivers 201. That is, the node control unit 202 can control the optical switch unit 300 and the transmission/reception unit 310 (the plurality of optical transceivers 201).

The optical transceiver 201 includes a coherent reception front-end unit 210, a coherent transmission front-end unit 220, a digital signal processing unit 230, a reception light source 240, a transmission light source 250, an ADC 260, and a DAC 270.

The reception light source 240 generates a local oscillation light r1 of a wavelength (frequency) set from the node control unit 202, and outputs the generated local oscillation light r1 to the coherent reception front-end unit 210. The transmission light source 250 generates a transmission light r2 of a wavelength (frequency) set from the node control unit 202, and outputs the generated transmission light r2 to the coherent transmission front-end unit 220.

The frequency (wavelength) of the local oscillation light r1 is a frequency (carrier frequency) of an input optical signal SO1 to be received, and the frequency of the transmission light r2 is a frequency of an output optical signal SO2 to be transmitted. For example, the local oscillation light r1 and the transmission light r2 have different frequencies, but may have the same frequency. By changing the frequencies of the local oscillation light r1 and the transmission light r2, the wavelength of the optical signal to be relayed can be switched. Namely, the input optical signal SO1 can be converted into the output optical signal SO2 having a different wavelength.

The coherent reception front-end unit 210 and the coherent transmission front-end unit 220 have configurations similar to those shown in FIG. 3. The coherent reception front-end unit 210 is an optical/electric conversion unit that converts an optical signal into an electric signal, and is a coherent detection unit that performs coherent detection. The coherent reception front-end unit 210 coherently detects, based on the local oscillation light r1, the input optical signal SO1 (reception optical signal) to be input, and outputs a generated analog signal SA1 (a first analog electric signal).

The Analog/Digital Converter (ADC) 260 performs AD conversion on the analog signal SA1 generated by the coherent reception front-end unit 210 and outputs a digital signal SD1 after the conversion (a first digital electric signal).

The Digital/Analog Converter (DAC) 270 performs DA conversion on the digital signal SD2 (a second digital electric signal) processed by the digital signal processing unit 230, and outputs an analog signal SA2 after the conversion (a second analog electric signal).

The coherent transmission front-end unit 220 is an electric/optical conversion unit that converts an electric signal into an optical signal, and is a coherent modulation unit that performs coherent modulation. The coherent transmission front-end unit 220 performs, based on the transmission light r2, coherent modulation on the analog signal SA2 acquired by DA conversion performed by the DAC 270, and outputs the generated output optical signal SO2 (a transmission optical signal).

For example, the input optical signal SO1 and the output optical signal SO2 are phase-modulated and polarization-multiplexed optical signals. The analog signals SA1 and SA2 and the digital signals SD1 and SD2 are four lanes (4 ch) of signals including an I_{X} signal of an I component (in-phase component) of an X polarization, a Q_{X} signal of a Q component (quadrature component) of the X polarization, an I_{Y} signal of an I component of a Y polarization, and a Q_{Y} signal of a Q component of the Y polarization.

The digital signal processing unit 230 performs digital signal processing on the digital signal SD1 converted by the ADC 260, and outputs a digital signal SD2 after the digital signal processing. The digital signal processing unit 230 is a digital circuit that performs predetermined digital signal processing for compensating for the signal quality. The digital signal processing unit 230 performs digital signal processing on each of some or all of the four lanes of signals including the I_{X} signal, the Q_{X} signal, the I_{Y} signal, and the Q_{Y} signal (the X polarization or the Y polarization).

The digital signal processing unit 230 does not perform processing that involves a large delay such as code error correction (data reproduction) and performs only specific signal compensation processing. Accordingly, it becomes possible to compensate for a required signal quality while suppressing signal delay. In this example embodiment, the digital signal processing unit 230 includes a wavelength dispersion compensation unit 231 that performs wavelength dispersion processing.

The wavelength dispersion compensation unit 231 compensates for wavelength dispersion that occurs in the optical signal in the optical transmission line in accordance with the control (setting) from the node control unit 202. The wavelength dispersion compensation unit 231 performs digital signal processing on the input digital signal SD1, thereby compensating for the set wavelength dispersion compensation amount.

The wavelength dispersion compensation performed by the digital signal processing can be achieved by convolution processing of an impulse response of an inverse transfer function of the optical transmission line and the received signal. Therefore, for example, the wavelength dispersion compensation unit 231 may be formed of a transversal filter (FIR filter). Since the characteristics of the optical transmission line can be modeled by the FIR filter, wavelength dispersion can be compensated by the FIR filter having the opposite characteristics.

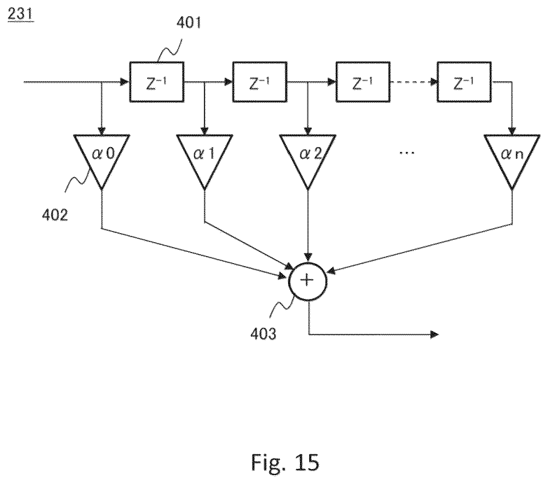

FIG. 15 is a configuration example of a case in which the wavelength dispersion compensation unit 231 is formed of an FIR filter (digital filter). In the example shown in FIG. 15, the wavelength dispersion compensation unit 231 includes a plurality of delay devices 401, a plurality of multipliers 402, and an adder 403. The plurality of delay devices 401 are connected in series and sequentially delay the input signal (digital signal) in units of one sample cycle. The multipliers 402 multiply the respective delayed signals by a filter coefficient, and the adder 403 adds the respective multiplied signals to output and the result of the addition. When the FIR filter is used, the wavelength dispersion compensation amount can be adjusted by changing the filter coefficient and the number of taps.

While the FIR filter performs time domain equalizing (TDE) that equalizes the received signal in a time delay domain, the FIR filter may achieve the same characteristics by frequency domain equalization (FDE) that equalizes the received signal in a frequency domain. By constituting the wavelength dispersion compensation unit with the FDE, the size of the circuit can be reduced more than that in the FIR filter.

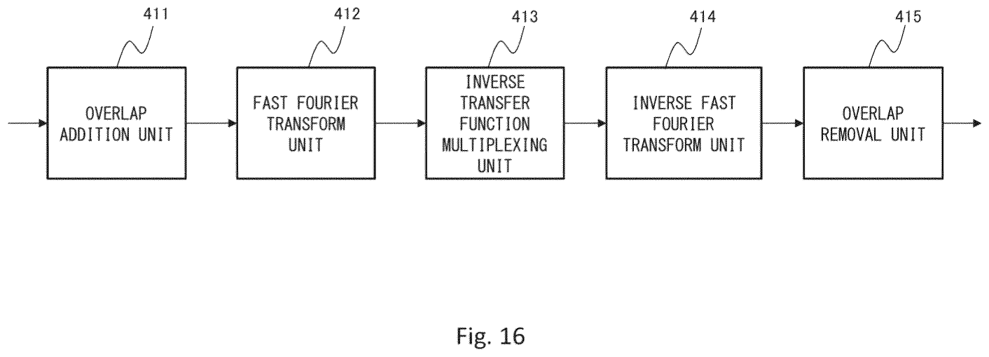

FIG. 16 is a configuration example in a case where the wavelength dispersion compensation unit 231 is configured by FDE processing. The wavelength dispersion compensation unit 231 shown in FIG. 16 is a configuration example of an overlap FDE, and includes an overlap addition unit 411, a fast Fourier transform unit 412, an inverse transfer function multiplexing unit 413, an inverse fast Fourier transform unit 414, and an overlap removal unit 415.

After the overlap addition unit 411 overlaps a part of signals before and after the input signal (digital signal), the fast Fourier transform unit 412 converts the overlapped signal into a frequency domain signal by Fast Fourier Transform (FFT). After the inverse transfer function multiplexing unit 413 multiplies the frequency domain signal by the inverse transfer function of the transmission line and equalizes the obtained value, the inverse fast Fourier transform unit 414 converts the equalized value into a time domain signal by Inverse Fast Fourier Transform (IFFT). The overlap removal unit 415 removes the overlap part from the signal that has been restored in the time domain to output the obtained signal. When FDE is used, the wavelength dispersion compensation amount can be adjusted by changing the inverse transfer function. Note that the overlap addition unit 411 and the overlap removal unit 415 may be omitted.

The node control unit 202 receives the control information from the control apparatus 100, and controls each part of the optical relay apparatus 200 based on the received control information. The node control unit 202 is an acquisition unit that acquires the reception wavelength information, the transmission wavelength information, and the optimal wavelength dispersion compensation amount from the parameter calculation unit 130. The node control unit 202 sets the frequency (wavelength) of the local oscillation light r1 for the reception light source 240 based on the acquired reception wavelength information and sets the frequency of the transmission light r2 for the transmission light source 250 based on the acquired transmission wavelength information. The node control unit 202 sets the wavelength dispersion compensation amount for the wavelength dispersion compensation unit 231 based on the acquired optimal wavelength dispersion compensation amount.

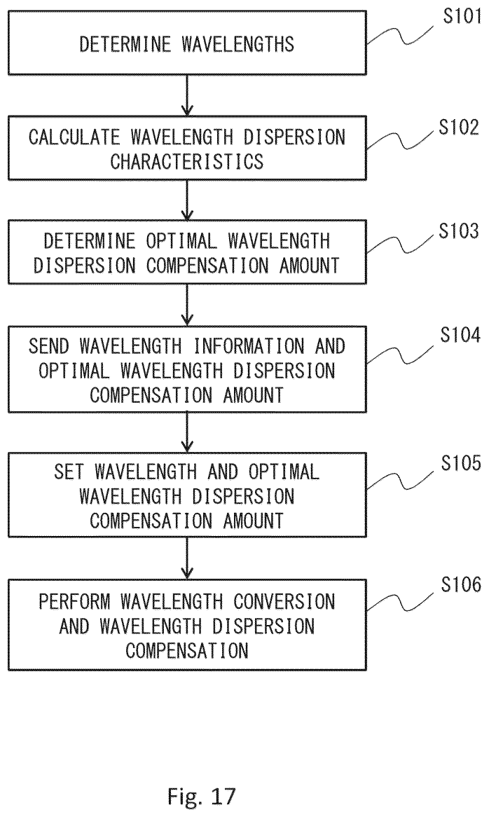

FIG. 17 shows an operation example of the optical network system according to this example embodiment. As shown in FIG. 17, first, the control apparatus 100 determines wavelengths used in the optical relay apparatus 200 (S101). The network control unit 120 determines the route of the path in the optical network 51, specifies the optical transmission line and optical relay apparatuses 200 on the route of the path, and determines the wavelength of each optical transmission line that has been specified, thereby determining the wavelengths before and after each of the optical relay apparatuses 200 (before and after the conversion), that is, the wavelengths of the optical signals transmitted and received by the optical relay apparatuses 200. The network control unit 120 outputs the reception wavelength information and the transmission wavelength information of the optical relay apparatus 200 by the determined wavelength, and outputs the transmission line information (distance) of the optical transmission lines before and after the optical relay apparatus 200. When the path includes a plurality of optical relay apparatuses 200, the following processing is performed for each of the optical relay apparatuses.

Next, the control apparatus 100 calculates the wavelength dispersion characteristics in the optical transmission lines before and after the optical relay apparatus 200 (S102). The parameter calculation unit 130 calculates the wavelength dispersion characteristics in the optical transmission lines before and after the optical relay apparatus 200 based on the reception wavelength information and the transmission wavelength information acquired from the network control unit 120. The parameter calculation unit 130 determines the wavelength dispersion characteristics of the optical transmission line on the front side of the optical relay apparatus 200 based on the wavelength of the reception wavelength information, and determines the wavelength dispersion characteristics of the optical transmission line on the rear side of the optical relay apparatus 200 based on the wavelength of the transmission wavelength information. When the transmission information includes the configuration and the type of the optical fiber, and the transmission characteristics, the wavelength dispersion characteristics may be determined based on the above information items.

The wavelength dispersion characteristics include, for example, an inclination of the wavelength dispersion amount accumulated with respect to the distance of the optical transmission line (distance-wavelength dispersion amount characteristics). Since the inclination of the wavelength dispersion amount varies depending on the wavelength, a table in which the wavelength (or the wavelength band) and the inclination of the wavelength dispersion amount are associated with each other may be stored in advance. The parameter calculation unit 130 may refer to this table to determine the wavelength dispersion characteristics corresponding to the wavelength.

Next, the control apparatus 100 determines the optimal wavelength dispersion compensation amount in the optical relay apparatus 200 (S103). The parameter calculation unit 130 determines the optimal wavelength dispersion compensation amount in the optical relay apparatus 200 based on the wavelength dispersion characteristics of the optical transmission lines before and after the optical relay apparatus 200 and the transmission line information (distance) of the optical transmission lines before and after the optical relay apparatus 200. The parameter calculation unit 130 obtains the wavelength dispersion amount accumulated in the optical transmission line on the front side (reception side), obtains the wavelength dispersion amount accumulated in the optical transmission line on the rear side (transmission side), and determines the optimal wavelength dispersion amount based on the wavelength dispersion amount on the front side and the wavelength dispersion amount on the rear side. In particular, the optimal wavelength dispersion amount is determined based on the wavelength dispersion amount accumulated between the transmission end station apparatus 30 and the optical relay apparatus 200 and the wavelength dispersion amount accumulated between the optical relay apparatus and the reception end station apparatus. For example, the parameter calculation unit 130 obtains the wavelength dispersion amount accumulated in the optical transmission line on the front side based on the wavelength dispersion characteristics of the optical transmission line on the front side of the optical relay apparatus 200 and the transmission line information (distance), and obtains the wavelength dispersion amount accumulated in the optical transmission line on the rear side based on the wavelength dispersion characteristics of the optical transmission line on the rear side of the optical relay apparatus 200 and the transmission line information (distance). Note that, in this example, the wavelength dispersion compensation amount is determined based on the wavelength dispersion characteristics and the transmission line information. However, since the wavelength dispersion characteristics correspond to the wavelength information, the wavelength dispersion compensation amount may be determined based on the wavelength information and the transmission line information. That is, the wavelength dispersion compensation amount in a plurality of optical relay apparatuses that form a path may be determined based on the wavelength information and the transmission line information in the path.

Next, the control apparatus 100 notifies the optical relay apparatus 200 of the information on the wavelength and the optimal wavelength dispersion compensation amount that have been determined (S104). The parameter calculation unit 130 notifies the optical relay apparatus 200 of the reception wavelength information and the transmission wavelength information determined in S101 and the optimal wavelength dispersion compensation amount determined in S103.

Next, the optical relay apparatus 200 sets the wavelength of the wavelength information and the optimal wavelength dispersion compensation amount sent from the control apparatus 100 (S105). The node control unit 202 sets the wavelength of the acquired reception wavelength information in the reception light source 240, sets the wavelength of the acquired transmission wavelength information in the transmission light source 250, and sets the acquired optimal wavelength dispersion compensation amount in the wavelength dispersion compensation unit 231.

Next, the optical relay apparatus 200 performs wavelength conversion and wavelength dispersion compensation (S106). The reception light source 240 generates the local oscillation light r1 of the set wavelength (frequency) and the transmission light source 250 generates the transmission light r2 of the set wavelength, thereby performing wavelength conversion in the optical transceiver 201. Further, the wavelength dispersion compensation unit 231 performs wavelength dispersion compensation processing based on the set compensation amount obtained by digital signal processing.

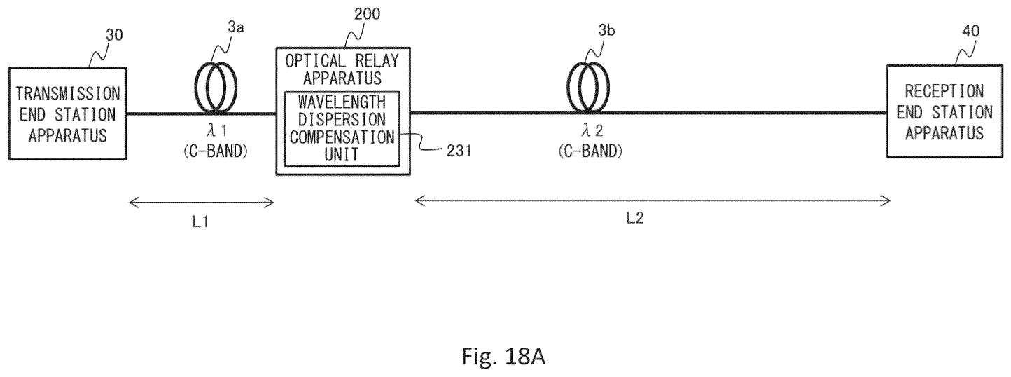

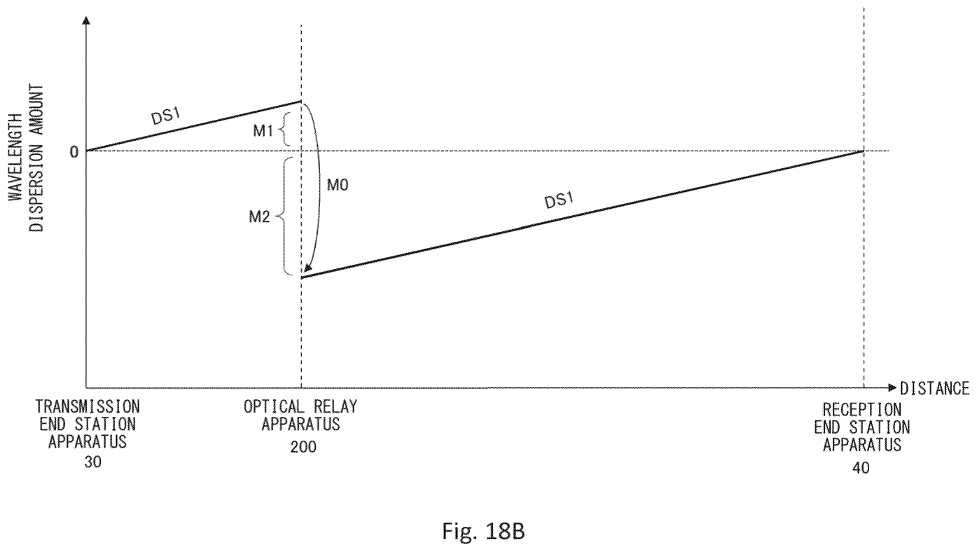

FIGS. 18A and 18B each show a specific example of the wavelength dispersion compensation by the control method according to this example embodiment. In this example embodiment, a compensation amount for canceling out the wavelength dispersion at the receiving end is used as the optimal wavelength dispersion compensation amount in the optical relay apparatus. That is, the optimal wavelength dispersion compensation amount in this example is a compensation amount based on the wavelength dispersion amount at the receiving end, and is a compensation amount obtained under a condition that the wavelength dispersion amount at the receiving end becomes smaller than a predetermined value.

As shown in FIG. 18A, in this example, one optical relay apparatus 200 is provided on the route of the path between the transmission end station apparatus 30 and the reception end station apparatus. The transmission end station apparatus 30 and the optical relay apparatus 200 are connected to each other via an optical transmission line 3a (a first optical transmission line), and the optical relay apparatus 200 and the reception end station apparatus 40 are connected to each other via an optical transmission line 3b (a second optical transmission line). For example, a distance L1 of the optical transmission line 3a and the distance L2 of the optical transmission line 3b are different from each other, and the distance L2 of the optical transmission line 3b is greater than the distance L1 of the optical transmission line 3a. However, they may have the same distance. An optical signal of a C-band wavelength λ1 is transmitted in the optical transmission line 3a, and an optical signal of a C-band wavelength 22 is transmitted in the optical transmission line 3b. That is, the optical relay apparatus 200 converts the optical signal of the wavelength λ1 to be received into the optical signal of the wavelength 22 and transmits the optical signal of the wavelength 22 after the conversion.

As shown in FIG. 18B, in the optical transmission line 3a of the first half, the wavelength of the optical signal is λ1. Therefore, the control apparatus 100 determines an inclination DS1 of the wavelength dispersion amount (e.g., 20 ps/nm/km) in the optical transmission line 3a in accordance with the wavelength λ1 (C-band). The control apparatus 100 obtains a wavelength dispersion amount M1 (=DS1×L1) accumulated in the optical transmission line 3a from the transmission end station apparatus 30 to the optical relay apparatus 200 by setting the wavelength dispersion at the time of transmission in the transmission end station apparatus 30 to zero using the inclination DS1 of the wavelength dispersion amount and the distance L1 of the optical transmission line 3a. Further, in the optical transmission line 3b of the latter half, the wavelength of the optical signal is λ2. Therefore, the control apparatus 100 determines the inclination DS1 of the wavelength dispersion amount in the optical transmission line 3b in accordance with the wavelength 22 (C-band). In this example, the wavelength λ1 and the wavelength 22 are the same C-band wavelength. Therefore, the inclination of the wavelength dispersion amount of the optical transmission line 3a and the inclination of the wavelength dispersion amount of the optical transmission line 3b are substantially equal to each other. The control apparatus 100 obtains a wavelength dispersion amount M2 (=DS1×L2) accumulated in the optical transmission line 3b from the optical relay apparatus 200 to the reception end station apparatus 40 under a condition that the wavelength dispersion at the time of reception in the reception end station apparatus 40 becomes zero using the inclination DS1 of the wavelength dispersion amount and the distance L2 of the optical transmission line 3b. The condition may instead be that the wavelength dispersion becomes within a predetermined range in the reception end station apparatus 40. The control apparatus 100 sets a total value of the obtained wavelength dispersion amounts M1 and M2 as the optimal wavelength dispersion compensation amount M0 (=M1+M2) in the optical relay apparatus 200.

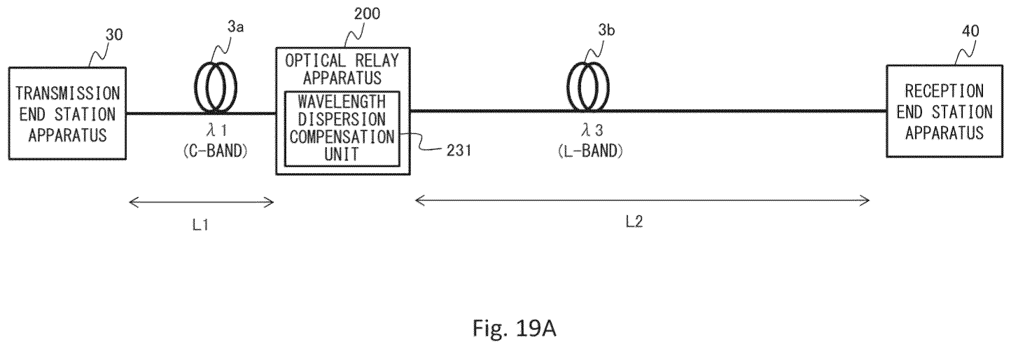

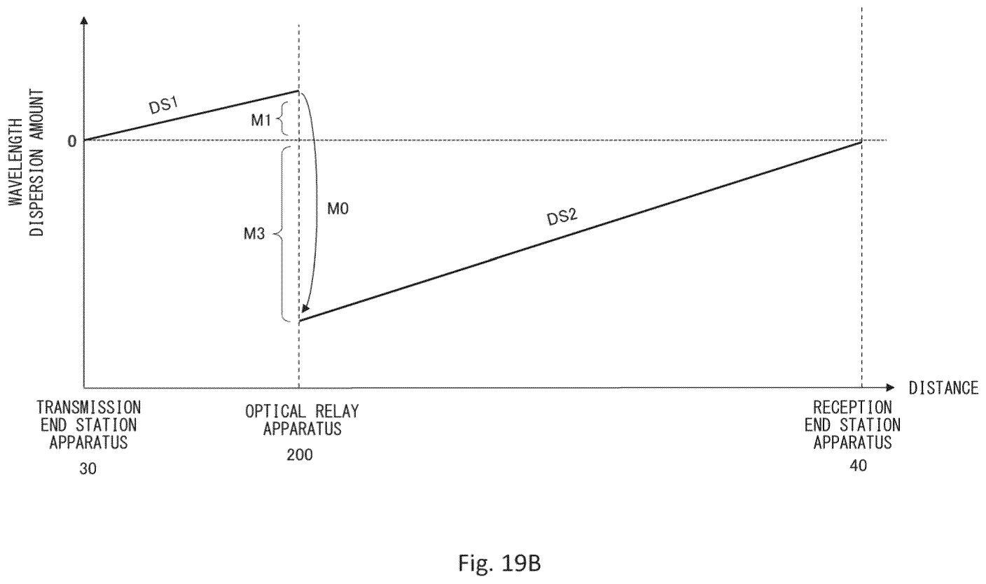

FIGS. 19A and 19B show other specific examples of wavelength dispersion compensation in a control method according to this example embodiment. As shown in FIG. 19A, the configurations of each of the apparatuses and the optical transmission line are similar to those shown in FIG. 18A. In this example, an optical signal of a C-band wavelength λ1 is transmitted in the optical transmission line 3a, and an optical signal of an L-band wavelength 23 is transmitted in the optical transmission line 3b.

As shown in FIG. 19B, the wavelength dispersion amount of the optical transmission line 3a of the first half is similar to that shown in FIG. 18B. The control apparatus 100 obtains the wavelength dispersion amount M1 (=DS1×L1) accumulated in the optical transmission line 3a based on an inclination DS1 of the wavelength dispersion amount that corresponds to the wavelength λ1 and the distance L1 of the optical transmission line 3a.

Further, in the optical transmission line 3b of the latter half, the wavelength of the optical signal is λ3. Therefore, the control apparatus 100 determines an inclination DS2 of the wavelength dispersion amount in the optical transmission line 3b (e.g., 25 ps/nm/km) in accordance with the wavelength λ3 (L-band). In this example, the wavelength λ1 is the C-band wavelength and the wavelength λ3 is the L-band wavelength. Therefore, the inclination of the wavelength dispersion amount of the optical transmission line 3b is larger than the inclination of the wavelength dispersion amount of the optical transmission line 3a. The control apparatus 100 obtains the wavelength dispersion amount M3 (=DS2× L2) accumulated in the optical transmission line 3b from the optical relay apparatus 200 to the reception end station apparatus 40 using the inclination DS2 of the wavelength dispersion amount and the distance L2 of the optical transmission line 3b under a condition that the wavelength dispersion at the time of reception in the reception end station apparatus 40 becomes zero. The control apparatus 100 sets a total value of the obtained wavelength dispersion amounts M1 and M3 in the optical relay apparatus 200 as the optimal wavelength dispersion compensation amount M0 (=M1+M3).

As described above, in this example embodiment, in the optical relay apparatus that performs wavelength conversion in units of channels, the analog signal that is output from the optical reception front-end is converted into a digital signal by ADC. After the digital signal processing is performed, the signal is converted into an analog signal again in DAC, the analog signal is turned around and relayed to the optical transmission front-end. At this time, in the digital signal processing unit, the wavelength dispersion distortion that occurs in the optical fiber transmission line is compensated in accordance with the line length of the network path (transmission line).

Specifically, the control apparatus obtains the optimal compensation amount in such a way that the wavelength dispersion becomes the smallest at the receiving end, and the optical relay apparatus performs wavelength dispersion compensation using the obtained optimal compensation amount. Accordingly, it is possible to minimize distortion of the optical signal due to wavelength dispersion at the receiving end. Further, since the wavelength dispersion distortion is canceled out at the receiving end, it is possible to reduce the power consumption of the wavelength dispersion compensation circuit. Further, the optimal compensation amount is set in accordance with the wavelength, whereby it is possible to appropriately compensate for the wavelength dispersion even in a case where C-band/L-band mutual wavelength conversion is performed.

### Second Example Embodiment

Next, with reference to the drawings, a second example embodiment will be described. In this example embodiment, a configuration and basic operations of the optical network system are similar to those in the first example embodiment.

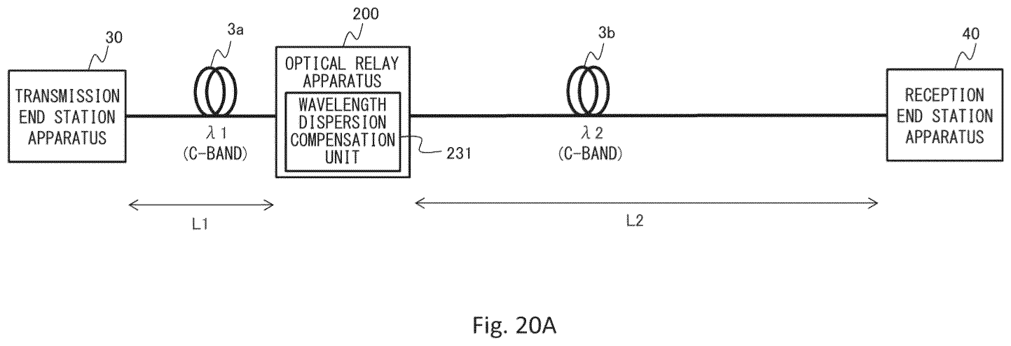

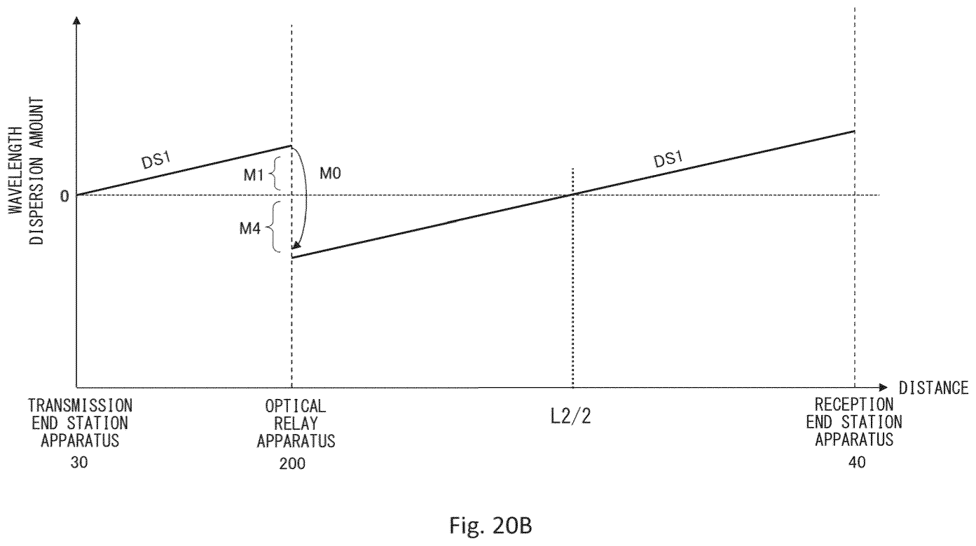

FIGS. 20A and 20B each show a specific example of wavelength dispersion compensation in a control method according to this example embodiment. In this example embodiment, an optimal wavelength dispersion compensation amount in an optical relay apparatus is determined for the purpose of suppressing non-linear distortion (SPM) in the entire transmission line. The larger the wavelength dispersion amount is, the larger the Peak-to-Average Power Ratio (PAPR) of the signal waveform is and the greater the influence of the non-linear effect is. Therefore, it becomes possible to suppress the non-linear effect by setting the wavelength dispersion compensation amount in such a way that a transmission section in which a peak value of signal amplitude becomes large is minimized as much as possible. For example, by performing wavelength dispersion compensation by the compensation amount at which the wavelength dispersion becomes zero at the center of the transmission line of the latter half, the influence of the non-linear effect can be suppressed more than that in the first example embodiment shown in FIGS. 18A and 18B. That is, the optimal wavelength dispersion compensation amount in this example is a compensation amount which is based on a predetermined wavelength dispersion amount range, including the center of the optical transmission line from the optical relay apparatus to the reception end station apparatus, and is a compensation amount obtained under a condition that a predetermined wavelength dispersion amount range including the center of the optical transmission line becomes smaller than a predetermined value. Note that the predetermined range, which is a condition for obtaining the optimal wavelength dispersion compensation amount is not limited to the range including the center of the optical transmission line. For example, the range of the optical transmission line of the first half may be set as the predetermined range or the range of the optical transmission line of the latter half may be set as the predetermined range. That is, the compensation amount with which it is possible to make the predetermined wavelength dispersion amount range of the optical transmission line defined in advance smaller than a predetermined value may be set as the optimal wavelength dispersion compensation amount. In other words, the optimal wavelength dispersion compensation amount is a compensation amount based on the absolute value of the wavelength dispersion amount from the optical relay apparatus to the reception end station apparatus, and is a compensation amount obtained under a condition that an absolute value of a wavelength dispersion amount at each point from the optical relay apparatus to the reception end station apparatus becomes smaller than a predetermined value.

The configurations of each of the apparatuses, the optical transmission lines, and the wavelengths shown in FIG. 20A are the same as those shown in FIG. 18A. As shown in FIG. 20B, the wavelength dispersion amount of the optical transmission line 3a of the first half is similar to that shown in FIG. 18B. The control apparatus 100 obtains a wavelength dispersion amount M1 (=DS1×L1) accumulated in the optical transmission line 3a based on an inclination DS1 of the wavelength dispersion amount that corresponds to the wavelength λ1 and a distance L1 of the optical transmission line 3a.

Further, in an optical transmission line 3b of the latter half, the wavelength of the optical signal is λ2. Therefore, the control apparatus 100 determines an inclination DS1 of the wavelength dispersion amount in the optical transmission line 3b in accordance with the wavelength λ2 (C-band). The control apparatus 100 obtains a wavelength dispersion amount M4 (=DS1×L2/2) accumulated from the optical relay apparatus 200 to the center of the optical transmission line 3b using the inclination DS1 of the wavelength dispersion amount and a distance L2 of the optical transmission line 3b under a condition that the wavelength dispersion in the half a distance L2/2 of the optical transmission line 3b becomes zero. This condition may instead be that the wavelength dispersion becomes within a predetermined range around the center of the optical transmission line 3b of the latter half or that an absolute value of the wavelength dispersion at each point becomes within a predetermined range over the entire optical transmission line 3b of the latter half. The control apparatus 100 sets a total value of the obtained wavelength dispersion amounts M1 and M4 in the optical relay apparatus 200 as the optimal wavelength dispersion compensation amount M0 (=M1+M4).

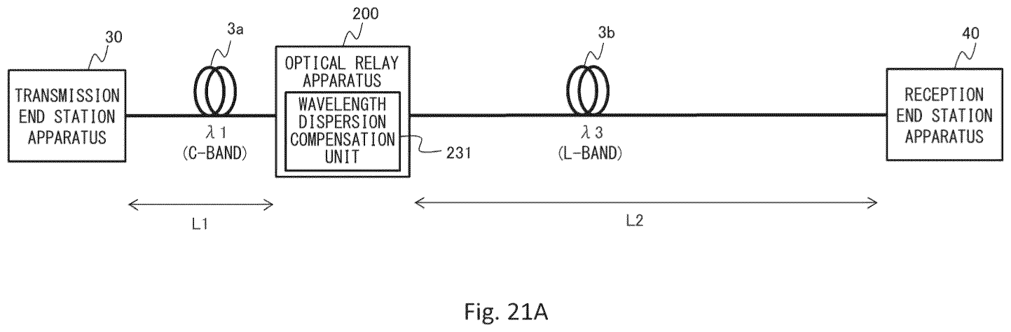

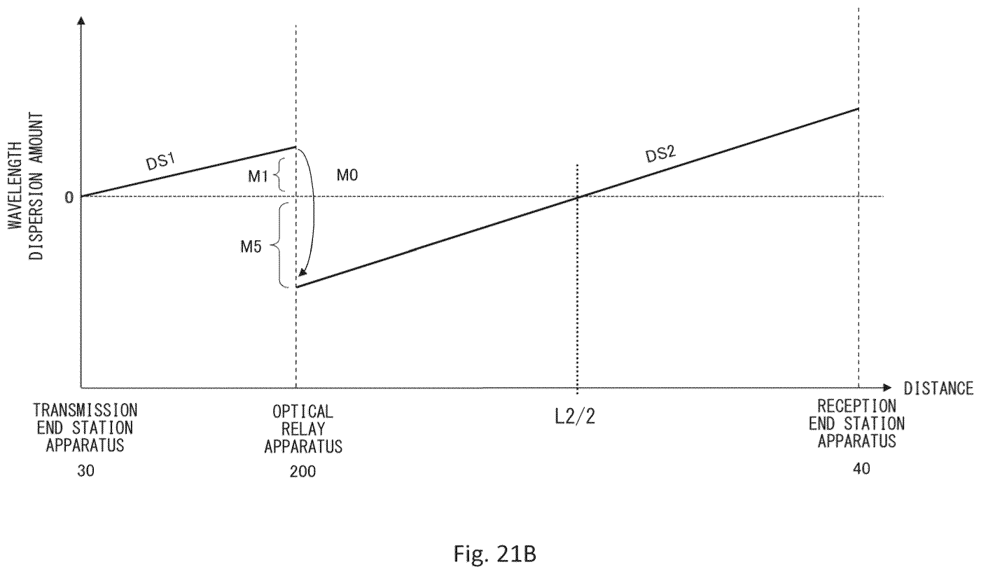

FIGS. 21A and 21B each show another specific example of the wavelength dispersion compensation by the control method according to this example embodiment. The configurations of each of the apparatuses, the optical transmission lines, and wavelengths shown in FIG. 21A are the same as those shown in FIG. 19A. The wavelength dispersion amount of the optical transmission line 3a of the first half in FIG. 21B is similar to that shown in FIG. 19B. The control apparatus 100 obtains the wavelength dispersion amount M1 (=DS1×L1) accumulated in the optical transmission line 3a based on the inclination DS1 of the wavelength dispersion amount that corresponds the wavelength λ1 and the distance L1 of the optical transmission line 3a.

Further, since the wavelength of the optical signal is λ3 in the optical transmission line 3b of the latter half, the control apparatus 100 determines the inclination DS2 of the wavelength dispersion amount in the optical transmission line 3b in accordance with the wavelength λ3 (L-band). The control apparatus 100 obtains, using the inclination DS2 of the wavelength dispersion amount and the distance L2 of the optical transmission line 3b, a wavelength dispersion amount M5 (=DS2× L2/2) accumulated from the optical relay apparatus 200 to the center of the optical transmission line 3b under a condition that the wavelength dispersion in half a distance L2/2 of the optical transmission line 3b becomes zero. The control apparatus 100 sets a total value of the obtained wavelength dispersion amounts M1 and M5 in the optical relay apparatus 200 as the optimal wavelength dispersion compensation amount M0 (=M1+M5).

As described above, in this example embodiment, in the optical network system according to the first example embodiment, the wavelength dispersion is compensated using the compensation amount for suppressing nonlinearity the most over the entire transmission line as the optimal wavelength dispersion compensation amount. Specifically, the control apparatus obtains the optimal compensation amount in such a way that the absolute value of the wavelength dispersion amount becomes small in the transmission line of the latter half, for example, in such a way that the wavelength dispersion amount becomes zero at the center of the transmission line of the latter half, and performs wavelength dispersion compensation in the optical relay apparatus by the obtained optimal compensation amount. Accordingly, even when the wavelength dispersion distortion remains at the receiving end, it is possible to minimize the non-linear distortion that is difficult to be compensated in the signal processing when viewed over the entire transmission line. It is therefore possible to maximize the signal quality.

### Third Example Embodiment

Next, with reference to the drawings, a third example embodiment will be described.

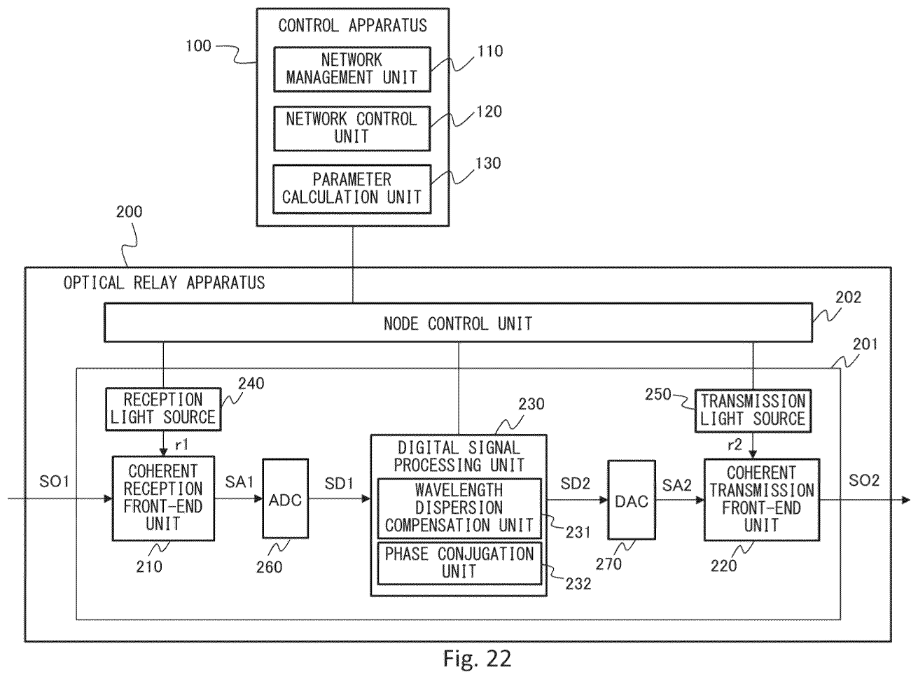

FIG. 22 shows a configuration example of each of apparatuses in an optical network system according to this example embodiment. As shown in FIG. 22, the configuration of the control apparatus 100 according to this example embodiment is similar to those of the first and second example embodiments.

In an optical relay apparatus 200 according to this example embodiment, a digital signal processing unit 230 of an optical transceiver 201 includes, besides the wavelength dispersion compensation unit 231, a phase conjugation unit 232. The other configurations in the optical relay apparatus 200 are similar to those in the first and second example embodiments.

The phase conjugation unit 232 performs phase conjugation processing on an input digital signal SD1. Like in the third examined example, the phase conjugation unit 232 generates a signal of wavelength dispersion whose sign is inverted from that in the wavelength dispersion accumulated in the optical transmission line of the first half by performing phase conjugation processing. That is, a signal equivalent to that obtained by performing wavelength dispersion compensation twice the wavelength dispersion accumulated in the optical transmission line of the first half is generated. The wavelength dispersion compensation unit 231 additionally performs wavelength dispersion processing on the signal that has been subjected to phase conjugation processing by the phase conjugation unit 232.

Specifically, the phase conjugation unit 232 obtains a complex conjugate of the input digital signal SD1. That is, as shown in the following Expression (1), the sign of Qch in each of the I_{X} signal, the Q_{X} signal, the I_{Y} signal, and the Q_{Y} signal is inverted. Ich and Qch may be swapped with each other.

$$\begin{matrix}[ Expression 1 ] & \\ \begin{matrix}{I}_{X} = Re [ ( {I}_{X} - {jQ}_{x} ) {e}^{j ∅ 1} ] \\ {Q}_{X} = Im [ ( {I}_{X} - {jQ}_{x} ) {e}^{j ∅1} ] \\ {I}_{Y} = Re ( {I}_{Y} - {jQ}_{Y} ) {e}^{j ∅2} ] \\ {Q}_{Y} = Im [ ( {I}_{Y} - {jQ}_{Y} ) {e}^{j ∅ 2} ]\end{matrix} \} & ( 1 )\end{matrix}$$

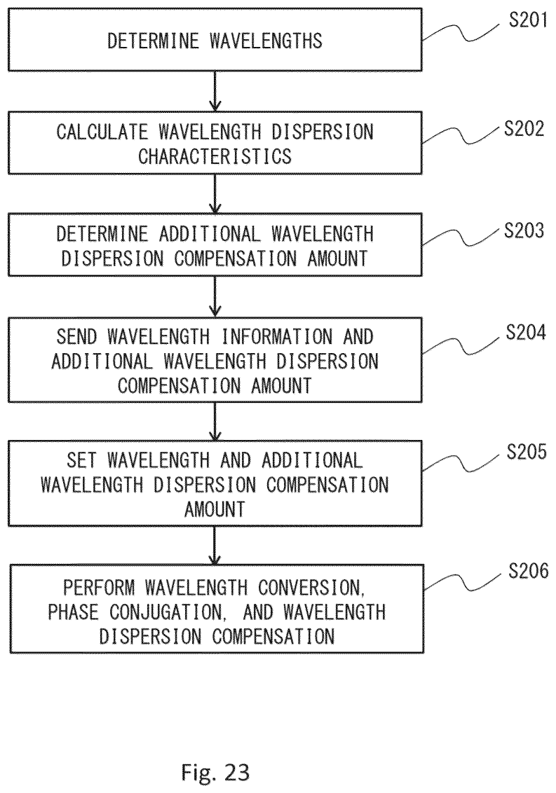

FIG. 23 shows an operation example of the optical network system according to this example embodiment. As shown in FIG. 23, first, like in the first and second example embodiments, the control apparatus 100 determines wavelengths to be used in the optical relay apparatus 200 (S201), and calculates the wavelength dispersion characteristics in the optical transmission lines before and after the optical relay apparatus 200 (S202).

Next, the control apparatus 100 determines an additional wavelength dispersion compensation amount in the optical relay apparatus 200 (S203). The additional wavelength dispersion compensation amount is a compensation amount compensated by wavelength dispersion processing performed in the wavelength dispersion compensation unit 231 in addition to the wavelength dispersion compensation by phase conjugation processing performed in the phase conjugation unit 232 in the optical relay apparatus 200. That is, in this example embodiment, the additional wavelength dispersion compensation amount is determined based on the wavelength dispersion compensation amount obtained by the phase conjugation processing.

That is, like in the first and second example embodiments, the parameter calculation unit 130 determines the optimal wavelength dispersion compensation amount in the optical relay apparatus 200 based on wavelength dispersion characteristics of the optical transmission lines before and after the optical relay apparatus 200 and the transmission line information (distance) of the optical transmission lines before and after the optical relay apparatus 200. Further, the parameter calculation unit 130 determines the additional wavelength dispersion compensation amount in the optical relay apparatus 200 by subtracting the wavelength dispersion compensation amount (phase conjugation compensation amount) compensated by phase conjugation in the optical relay apparatus 200 from the obtained optimal wavelength dispersion compensation amount. The phase conjugation compensation amount is twice the wavelength dispersion amount accumulated in the optical transmission line on the front side (reception side). That is, the wavelength dispersion compensation amount by the phase conjugation processing is obtained based on the wavelength dispersion amount accumulated in the optical transmission line on the front side.

Next, the control apparatus 100 notifies the optical relay apparatus 200 of the information of the wavelength and the additional wavelength dispersion compensation amount that have been determined (S204). The parameter calculation unit 130 notifies the optical relay apparatus 200 of the reception wavelength information, the transmission wavelength information, and the additional wavelength dispersion compensation amount.

Next, the optical relay apparatus 200 sets the wavelength of the wavelength information and the additional wavelength dispersion compensation amount sent from the control apparatus 100 (S205). The node control unit 202 sets the wavelength of the acquired reception wavelength information in the reception light source 240, sets the wavelength of the acquired transmission wavelength information in the transmission light source 250, and sets the acquired additional wavelength dispersion compensation amount in the wavelength dispersion compensation unit 231.

Next, the optical relay apparatus 200 performs wavelength conversion, phase conjugation, and wavelength dispersion compensation (S206). The wavelength conversion is performed in the optical transceiver 201 by the wavelength of the reception light source 240 and the wavelength of the transmission light source 250 that have been set. Further, the phase conjugation unit 232 performs phase conjugation processing by phase conjugation, and the wavelength dispersion compensation unit 231 performs wavelength dispersion compensation processing on the signal after phase conjugation processing based on the set compensation amount.

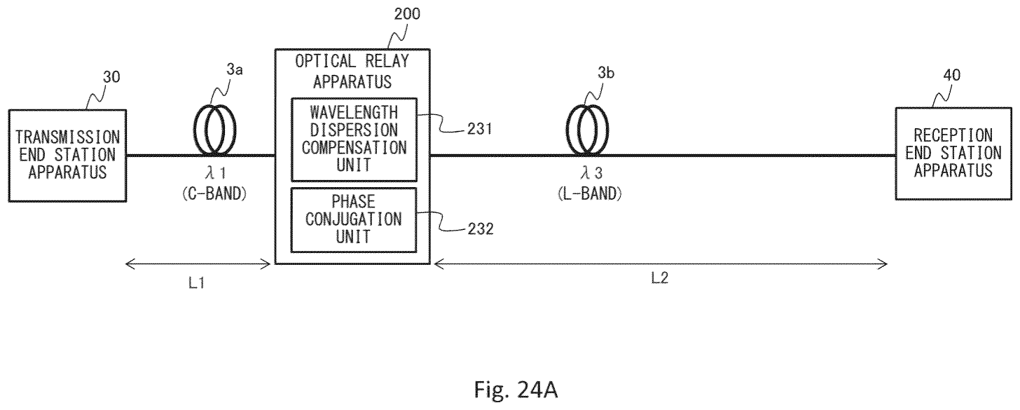

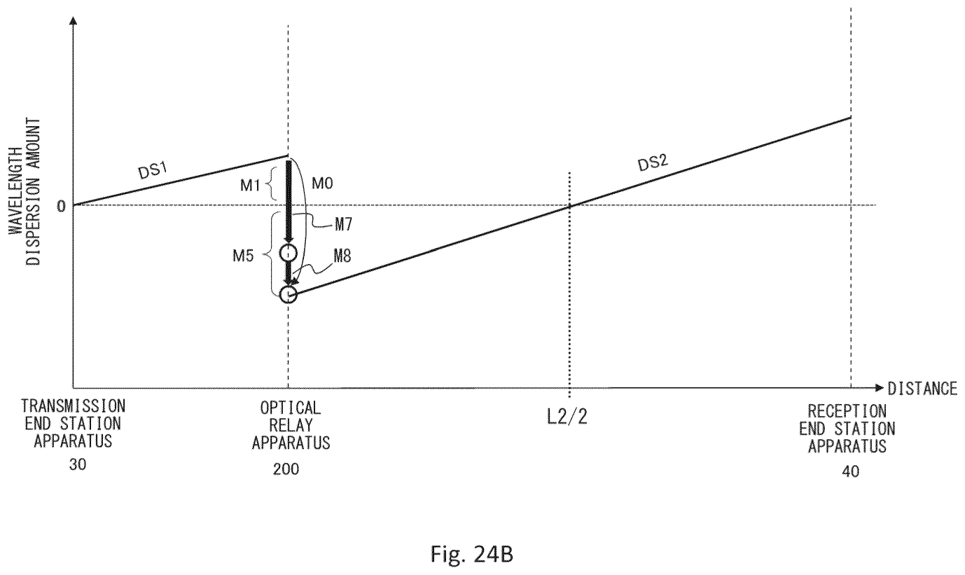

FIGS. 24A and 24B each show a specific example of the wavelength dispersion compensation by the control method according to this example embodiment. The basic configurations of each of the apparatuses, the optical transmission lines, and wavelengths shown in FIG. 24A are similar to those shown in FIG. 21A, and in this example, this example embodiment is applied to the configuration of FIG. 21A according to the second example embodiment. Note that this example embodiment may be applied to the first example embodiment.

As shown in FIG. 24B, the control apparatus 100 obtains an optimal wavelength dispersion compensation amount M0 compensated in the optical relay apparatus 200 from a wavelength dispersion amount M1 accumulated in the optical transmission line 3a and a wavelength dispersion amount M5 accumulated up to the center of the optical transmission line 3b, like in the second example embodiment. Further, the control apparatus 100 obtains, from the wavelength dispersion amount M1 accumulated in the optical transmission line 3a, a phase conjugation compensation amount M7 (=M1×2) compensated by phase conjugation. The control apparatus 100 sets the compensation amount obtained by subtracting the phase conjugation compensation amount M7 from the optimal wavelength dispersion compensation amount M0 in the optical relay apparatus 200 as an additional wavelength dispersion compensation amount M8 (=M0−M7).

### As described above, in this example embodiment, in the digital signal

processing unit of the optical relay apparatus in the first and second example embodiments, wavelength dispersion compensation is performed by the phase conjugation, and further wavelength dispersion compensation is additionally performed by the wavelength dispersion compensation unit. In the control apparatus, the additional wavelength dispersion compensation amount is obtained in consideration of the compensation amount obtained by the phase conjugation. As described above, since the phase conjugation can be implemented by a simple calculation, the size of the circuit can be reduced by combining the optical phase conjugation circuit with the wavelength dispersion compensation circuit.

### Fourth Example Embodiment

Next, with reference to the drawings, a fourth example embodiment will be described.

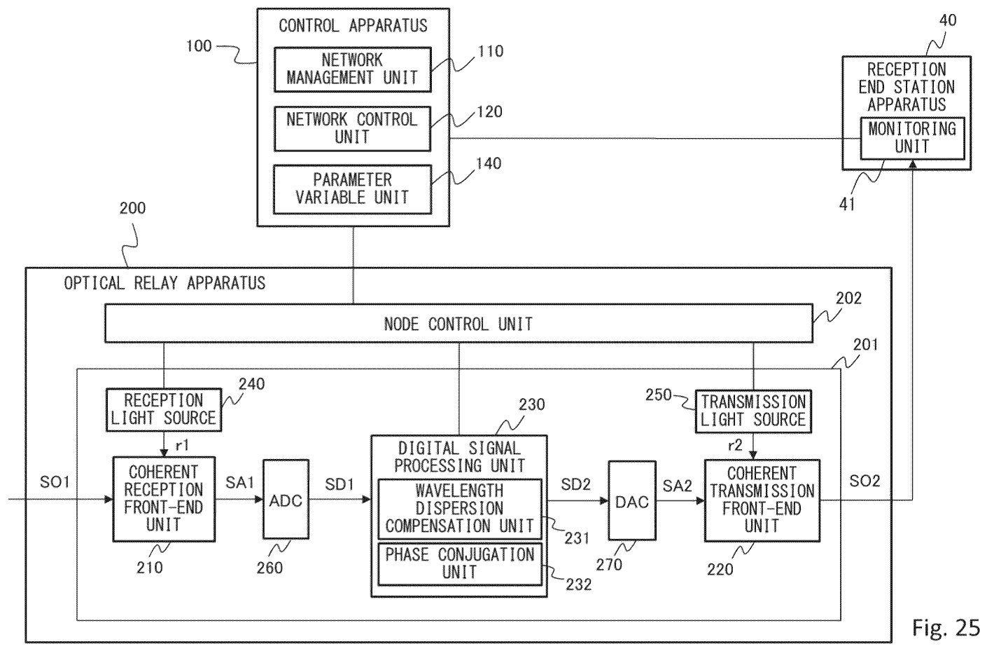

FIG. 25 shows a configuration example of each apparatus in an optical network system according to this example embodiment. As shown in FIG. 25, a configuration of an optical relay apparatus 200 according to this example embodiment is similar to that of the third example embodiment. Note that an optical relay apparatus similar to those shown in the first and second example embodiments may be used.

In this example embodiment, a reception end station apparatus 40 includes a monitoring unit 41. The monitoring unit 41 monitors a signal quality of an optical signal received from an optical transmission line. The monitoring unit 41 notifies a control apparatus 100 of signal quality information indicating a monitored signal quality. For example, the signal quality to be monitored is Bit Error Rate (BER), Q value, Error Vector Magnitude (EVM) or the like, and the signal quality information includes at least any one of these items.

The control apparatus 100 according to this example embodiment includes a parameter variable unit 140 in place of the parameter calculation unit 130. The other configurations of the control apparatus 100 are similar to those in the first to third example embodiments. Note that the parameter calculation unit 130 may include the function of the parameter variable unit 140.

Like in the parameter calculation unit 130 according to the first to third example embodiments, the parameter variable unit 140 calculates an optimal wavelength dispersion compensation amount and an additional wavelength dispersion compensation amount in the optical relay apparatus 200, further acquires the signal quality information from the reception end station apparatus 40, and adjusts (varies) the calculated wavelength dispersion compensation amount based on the acquired signal quality information. It can also be said that the parameter variable unit 140 determines the wavelength dispersion compensation amount of the optical relay apparatus 200 based on the signal quality information of the reception end station apparatus 40.

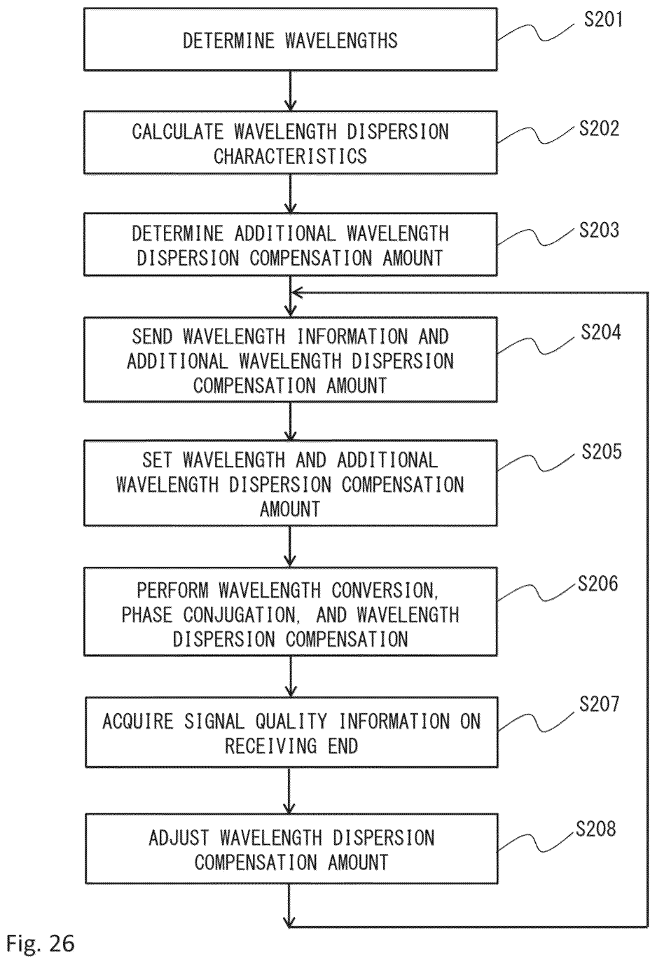

FIG. 26 shows an operation example of the optical network system according to this example embodiment. As shown in FIG. 26, like in the third example embodiment, the control apparatus 100 (the parameter variable unit 140) calculates the wavelength dispersion compensation amount, and the optical relay apparatus 200 performs wavelength dispersion compensation by the calculated wavelength dispersion compensation amount (S201-S206). In this example, like in the third example embodiment, the compensation is performed to obtain the additional wavelength dispersion compensation amount. Alternatively, like in the first and second example embodiments, the wavelength dispersion compensation may be performed by the optimal wavelength dispersion compensation amount.

Next, the control apparatus 100 acquires signal quality information on the receiving end (S207). The monitoring unit 41 of the reception end station apparatus 40 monitors, regularly, for example, the signal quality of the received optical signal, and notifies the control apparatus 100 of signal quality information indicating the result of the monitoring. The network control unit 120 acquires the signal quality information sent from the monitoring unit 41.

Next, the control apparatus 100 adjusts the wavelength dispersion compensation amount set in the optical relay apparatus 200 (S208). The parameter variable unit 140 adjusts, based on the signal quality information acquired from the reception end station apparatus 40, the wavelength dispersion compensation amount that has already been sent to the optical relay apparatus 200 and has been set therein. After that, in and after S204, the control apparatus 100 notifies the optical relay apparatus 200 of the wavelength dispersion compensation amount after the adjustment, and the optical relay apparatus 200 performs wavelength dispersion compensation by the compensation amount after the adjustment. For example, the adjustment of the wavelength dispersion compensation amount is repeated until the signal quality in the reception end station apparatus 40 becomes within a predetermined range or until the signal quality becomes the highest.

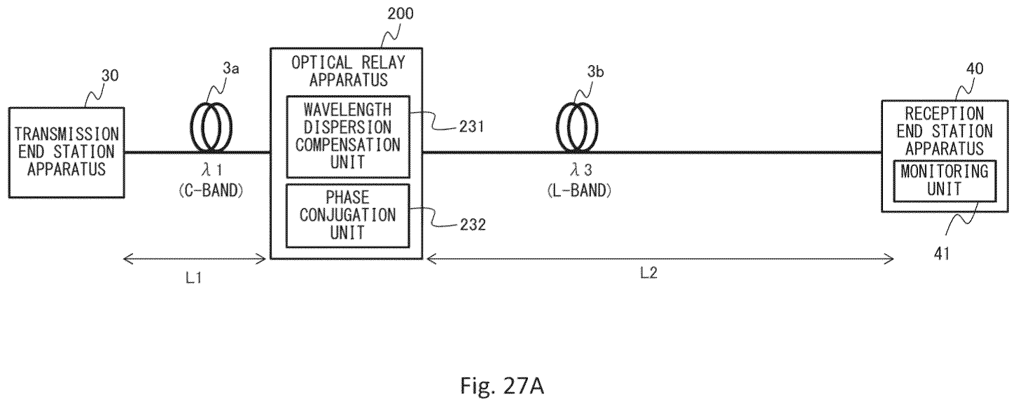

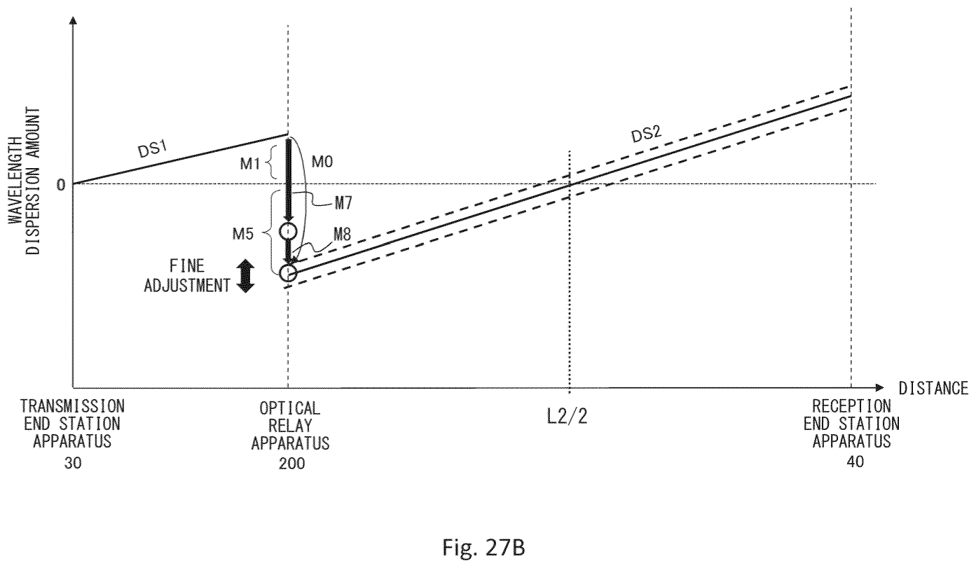

FIGS. 27A and 27B each show a specific example of wavelength dispersion compensation by a control method according to this example embodiment. The basic configurations of each of the apparatuses, the optical transmission lines, and wavelengths shown in FIG. 27A are similar to those shown in FIG. 24A. In this example, this example embodiment is applied to the configuration in FIG. 24A according to the third example embodiment. Note that this example embodiment may be applied to the first and second example embodiments.

As shown in FIG. 27B, like in the third example embodiment, the control apparatus 100 obtains an additional wavelength dispersion compensation amount M8 from the optimal wavelength dispersion compensation amount M0, and sets the additional wavelength dispersion compensation amount M8 in the optical relay apparatus 200. The optical relay apparatus 200 compensates for a phase conjugation compensation amount M7 by the phase conjugation unit 232, and compensates for the additional wavelength dispersion compensation amount M8 by the wavelength dispersion compensation unit 231.

The reception end station apparatus 40 receives the optical signal compensated by the optical relay apparatus 200 and monitors the quality of the received optical signal. The control apparatus 100 adaptively adjusts the wavelength dispersion compensation amount in such a way that the signal quality becomes a maximum based on the signal quality information indicating the signal quality monitored by the reception end station apparatus 40. That is, the control apparatus 100 adjusts the wavelength dispersion compensation amount that has already been set (in this example, additional wavelength dispersion compensation amount) in accordance with the signal quality of the reception end station apparatus 40, and re-sets the adjusted wavelength dispersion compensation amount in the optical relay apparatus 200. Only the amount of change of the wavelength dispersion compensation amount may be set in the optical relay apparatus 200. For example, the wavelength dispersion compensation amount may be changed on the positive side or the negative side by a predetermined step and a wavelength dispersion compensation amount where the signal quality becomes the highest may be obtained. Note that, by adjusting the wavelength dispersion compensation amount slowly and slightly, the optimization can be performed even during the operation.

As described above, in this example embodiment, the optical network system according to the first to third example embodiments varies the wavelength dispersion compensation amount in the optical relay apparatus and performs feedback control based on the signal quality of the optical signal at the receiving end. Accordingly, it is possible to optimize the wavelength dispersion amount in such a way that the signal quality becomes a maximum in the actual transmission line.

### Other Example Embodiments

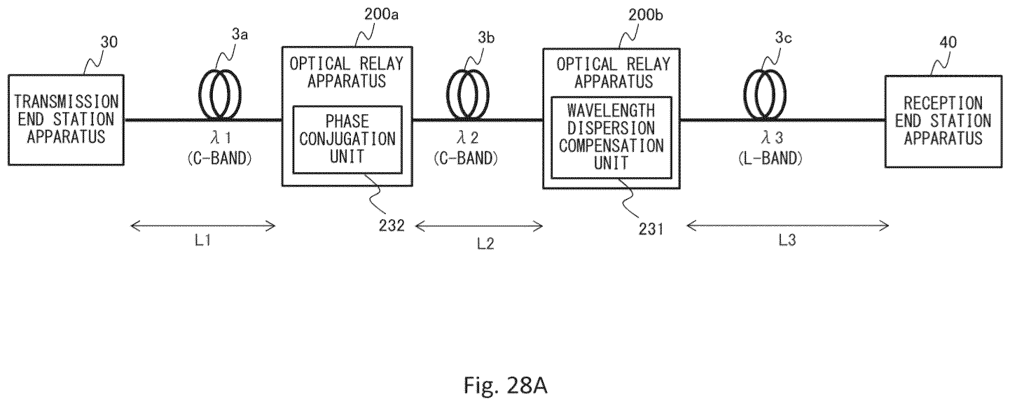

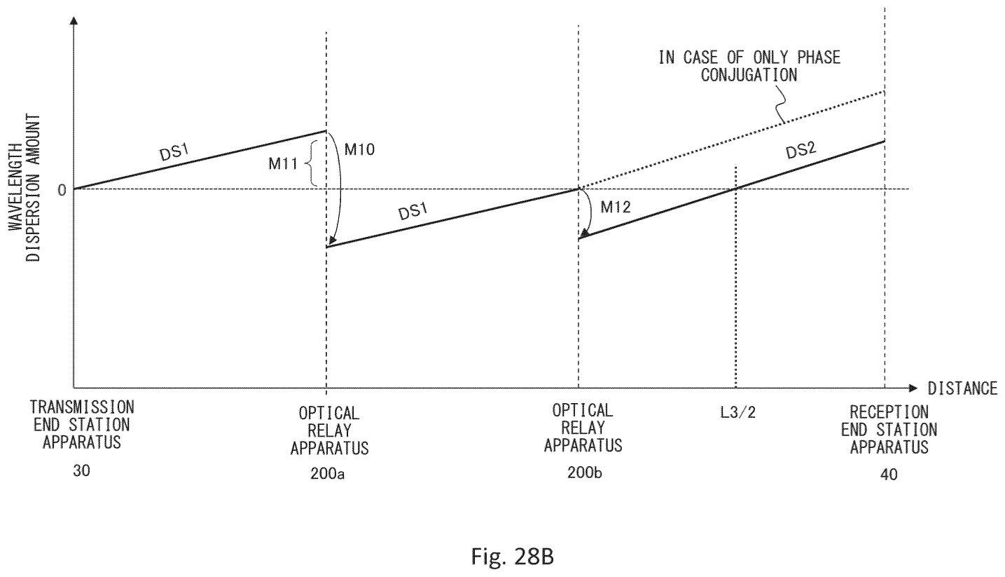

With reference to FIGS. 28A and 28B to FIGS. 30A and 30B, examples in which the method for controlling the wavelength dispersion compensation described in the first to fourth example embodiments is applied to a plurality of optical relay apparatuses on a route will be described.

In the examples shown in FIGS. 28A and 28B, as shown in FIG. 28A, an optical relay apparatus 200a (a first optical relay apparatus) and an optical relay apparatus 200b (a second optical relay apparatus) are provided on a route of a path between a transmission end station apparatus 30 and a reception end station apparatus 40. The transmission end station apparatus 30 and the optical relay apparatus 200a are connected to each other via an optical transmission line 3a (a first optical transmission line), the optical relay apparatus 200a and the optical relay apparatus 200b are connected to each other via an optical transmission line 3b (a second optical transmission line), and the optical relay apparatus 200b and the reception end station apparatus 40 are connected to each other via an optical transmission line 3c (a third optical transmission line). For example, while a distance L1 of the optical transmission line 3a, a distance L2 of the optical transmission line 3b, and a distance L3 of the optical transmission line 3c are different from one another, they may be the same distance. An optical signal of a C-band wavelength λ1 is transmitted in the optical transmission line 3a, an optical signal of a C-band wavelength λ2 is transmitted in the optical transmission line 3b, and an optical signal of an L-band wavelength λ3 is transmitted in the optical transmission line 3c.

In the optical relay apparatus 200a, of the configurations of the optical relay apparatus described in the third example embodiment, only the phase conjugation unit 232 is included in the digital signal processing unit 230. The optical relay apparatus 200a is, for example, similar to that in the third examined example. The optical relay apparatus 200b has a configuration the same as those in the first and second example embodiments, and includes only the wavelength dispersion compensation unit 231 in the digital signal processing unit 230. Note that the optical relay apparatus 200b may be the optical relay apparatus in the third example embodiment.

As shown in FIG. 28B, in the optical relay apparatus 200a, only wavelength compensation by phase conjugation is performed. Therefore, from an inclination DS1 of the wavelength dispersion amount in accordance with the wavelength λ1 (C-band) and the distance L1 of the optical transmission line 3a, a wavelength dispersion amount M11 accumulated in the optical transmission line 3a is obtained, and a phase conjugation compensation amount in the optical relay apparatus 200a is M10 (=M11×2). That is, the wavelength dispersion amount in the optical relay apparatus 200a after the compensation becomes-M11. Note that it is not necessary to set the wavelength dispersion compensation amount for the optical relay apparatus 200a.

The wavelength dispersion compensation amount in the optical relay apparatus 200b is determined in consideration of the wavelength dispersion amount compensated in the optical relay apparatus 200a. That is, in the optical relay apparatus 200b, using the inclination DS1 of the wavelength dispersion amount in accordance with the wavelength λ2 (C-band) and the distance L2 of the optical transmission line 3b, a wavelength dispersion amount that accumulates in the optical transmission line 3b from the optical relay apparatus 200a to the optical relay apparatus 200b is obtained as a wavelength dispersion amount −M11 after the compensation in the optical relay apparatus 200a. In this example, the wavelength dispersion amount is canceled out in the optical relay apparatus 200b to be zero.

The accumulated wavelength dispersion amount being zero in the optical relay apparatus 200b means that, when the relay operation is performed only by optical phase configuration, there is substantially no distortion relieving effect on wavelength dispersion, and there is no waveform distortion relieving effect in optical transmission line 3c. Therefore, in this example, like in the second example embodiment, the wavelength dispersion is compensated in such a way that the wavelength dispersion amount becomes zero in the center of the optical transmission line 3c. That is, the control apparatus 100 obtains a wavelength dispersion amount M12 (=DS2×L3/2) accumulated from the optical relay apparatus 200b to the center of the optical transmission line 3c using the inclination DS2 of the wavelength dispersion amount in accordance with the wavelength λ3 (L-band) and the distance L3 of the optical transmission line 3c under a condition that the wavelength dispersion in half a distance L3/2 of the optical transmission line 3c becomes zero. Since the wavelength dispersion amount is zero in the optical relay apparatus 200b, the obtained wavelength dispersion amount M12 is set in the optical relay apparatus 200b as the optimal wavelength dispersion compensation amount. Like in the first example embodiment, the wavelength dispersion compensation amount may be obtained under a condition that the wavelength dispersion amount in the reception end station apparatus 40 becomes zero.

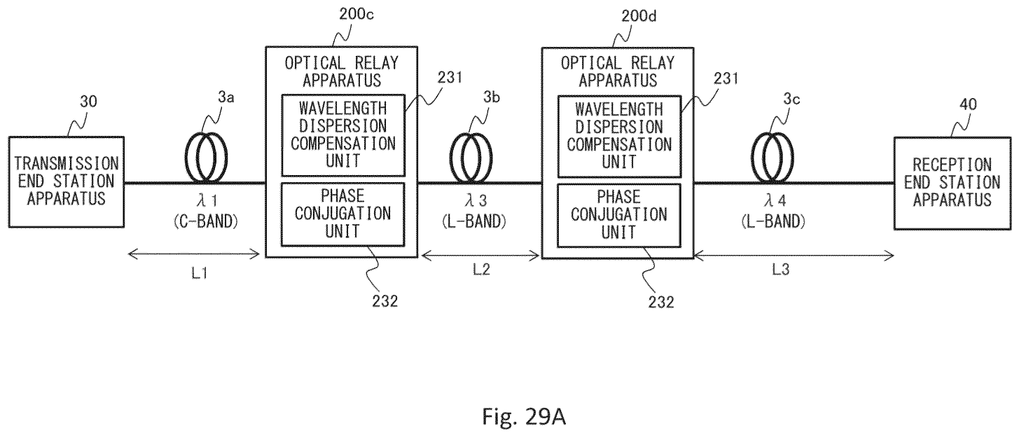

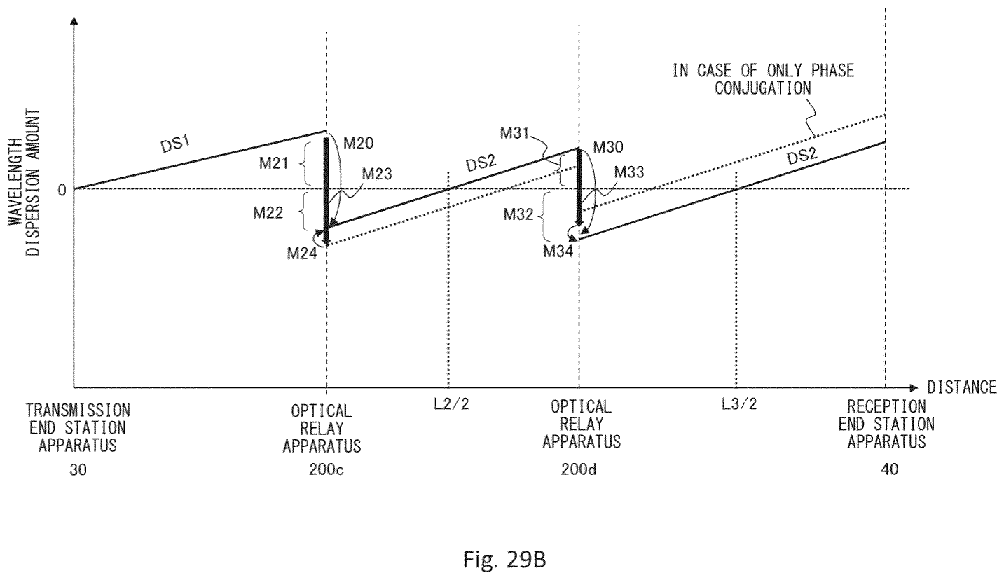

In the examples shown in FIGS. 29A and 29B, as shown in FIG. 29A, optical relay apparatuses 200c and 200d are provided on the route of the path between a transmission end station apparatus 30 and a reception end station apparatus 40. Like in FIG. 28A, while a distance L1 of an optical transmission line 3a between the transmission end station apparatus 30 and the optical relay apparatus 200c, a distance L2 of an optical transmission line 3b between the optical relay apparatus 200c and the optical relay apparatus 200d, and a distance L3 of the optical transmission line 3c between the optical relay apparatus 200d and the reception end station apparatus 40 are different from one another, they may be the same distance. An optical signal of a C-band wavelength λ1 is transmitted in the optical transmission line 3a, an optical signal of an L-band wavelength λ3 is transmitted in the optical transmission line 3b, and an optical signal of an L-band wavelength λ4 is transmitted in the optical transmission line 3c. Each of the optical relay apparatuses 200c and 200d is the optical relay apparatus in the third example embodiment, and the digital signal processing unit 230 includes a wavelength dispersion compensation unit 231 and a phase conjugation unit 232. Note that the optical relay apparatuses 200c and 200d may be optical relay apparatuses in the first and second example embodiments.

As shown in FIG. 29B, in the setting of the optical relay apparatus 200c, the control apparatus 100 obtains a wavelength dispersion amount M21 accumulated in the optical transmission line 3a from an inclination DS1 of the wavelength dispersion amount in accordance with the wavelength λ1 (C-band) and the distance L1 of the optical transmission line 3a, obtains a wavelength dispersion amount M22 accumulated up to the center of the optical transmission line 3b from an inclination DS2 of the wavelength dispersion amount in accordance with the wavelength λ3 (L-band) and the half a distance L2/2 of the optical transmission line 3b, and obtains an optimal wavelength dispersion compensation amount M20 (=M21+M22) compensated by the optical relay apparatus 200c. The control apparatus 100 sets, in the optical relay apparatus 200c, an additional wavelength dispersion compensation amount M24 (=M20−M23) in the optical relay apparatus 200c, from the optimal wavelength dispersion amount M20 and a phase conjugation compensation amount M23 (=M21×2) compensated by phase conjugation. In this example, the phase conjugation compensation amount M23 is larger than the optimal wavelength dispersion compensation amount M20. Therefore, the additional wavelength dispersion compensation amount M24 is the compensation in the positive direction in the perpendicular axis of the graph (axis indicating the wavelength dispersion amount) in FIG. 29B. When, for example, the wavelength dispersion compensation amount that compensates for the accumulated wavelength dispersion amount M is denoted by M, the direction in which the compensation amount becomes smaller than M is the positive direction in the perpendicular axis of the graph, and the direction in which the compensation amount becomes larger than M is the negative direction in the perpendicular axis of the graph. Note that the wavelength dispersion compensation amount may be obtained under a condition that the wavelength dispersion amount in the optical relay apparatus 200d becomes zero.

Further, in the setting of the optical relay apparatus 200d, the control apparatus 100 obtains a wavelength dispersion amount M31 accumulated in the optical transmission line 3b from the optical relay apparatus 200c to the optical relay apparatus 200d as a wavelength dispersion amount-M22 after the compensation in the optical relay apparatus 200c using the inclination DS2 of the wavelength dispersion amount in accordance with the wavelength λ3 (L-band) and the distance L2 of the optical transmission line 3b. The control apparatus 100 obtains, using the inclination DS2 of the wavelength dispersion amount in accordance with the wavelength λ4 (L-band) and half a distance L3/2 of the optical transmission line 3c, the wavelength dispersion amount M32 accumulated up to the center of the optical transmission line 3c and obtains an optimal wavelength dispersion compensation amount M30 (=M31+M32) compensated by the optical relay apparatus 200d. The control apparatus 100 sets, in the optical relay apparatus 200d, an additional wavelength dispersion compensation amount M34 (=M30−M33) in the optical relay apparatus 200d from the optimal wavelength dispersion amount M30 and a phase conjugation compensation amount M33 (=M31×2) compensated by phase conjugation. Note that the wavelength dispersion compensation amount may be obtained under a condition that the wavelength dispersion amount in the reception end station apparatus 40 becomes zero.

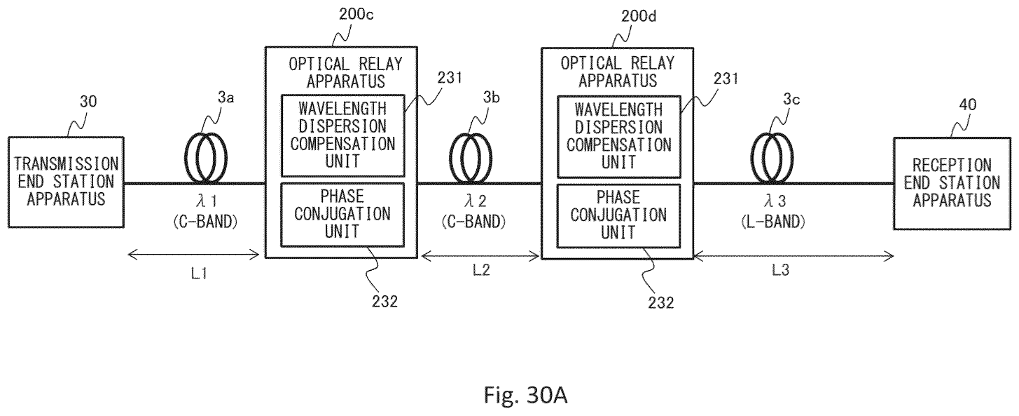

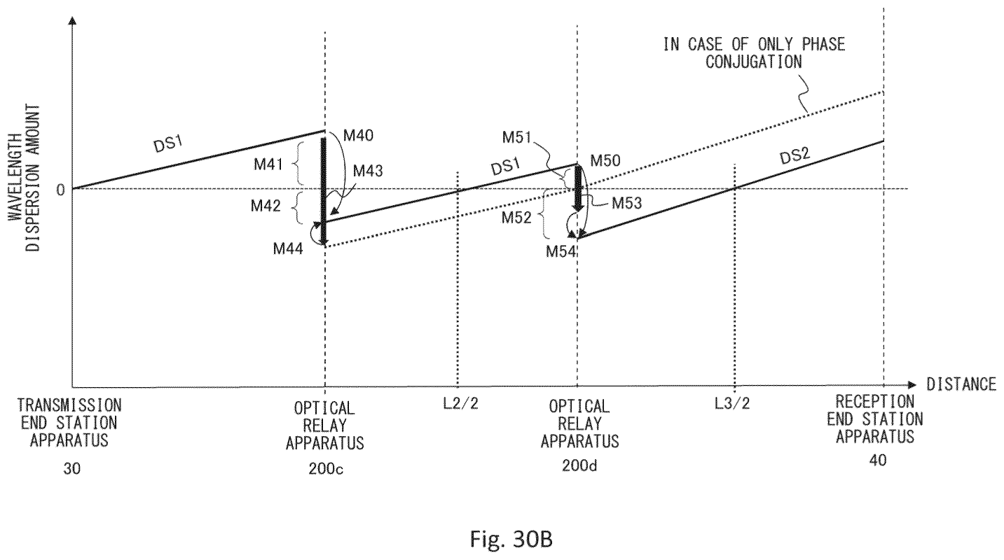

In the examples shown in FIGS. 30A and 30B, as shown in FIG. 30A, like in FIG. 29A, optical relay apparatuses 200c and 200d are provided on the route of the path between a transmission end station apparatus 30 and a reception end station apparatus 40. An optical signal of a C-band wavelength λ1 is transmitted in an optical transmission line 3a, an optical signal of a C-band wavelength λ2 is transmitted in an optical transmission line 3b, and an optical signal of an L-band wavelength λ3 is transmitted in an optical transmission line 3c.

As shown in FIG. 30B, in the setting of the optical relay apparatus 200c, a control apparatus 100 obtains a wavelength dispersion amount M41 accumulated in the optical transmission line 3a from an inclination DS1 of the wavelength dispersion amount in accordance with the wavelength λ1 (C-band) and a distance L1 of the optical transmission line 3a, obtains a wavelength dispersion amount M42 accumulated up to the center of the optical transmission line 3b from the inclination DS1 of the wavelength dispersion amount in accordance with the wavelength λ2 (C-band) and the half a distance L2/2 of the optical transmission line 3b, and obtains an optimal wavelength dispersion compensation amount M40 (=M41+M42) compensated by the optical relay apparatus 200c. The control apparatus 100 sets, in the optical relay apparatus 200c, an additional wavelength dispersion compensation amount M44 (=M40-M43) in the optical relay apparatus 200c from the optimal wavelength dispersion compensation amount M40 and a phase conjugation compensation amount M43 (=M41× 2) compensated by phase conjugation.

Further, in the setting of the optical relay apparatus 200d, the control apparatus 100 obtains a wavelength dispersion amount M51 accumulated in the optical transmission line 3b from the optical relay apparatus 200c to the optical relay apparatus 200d using the inclination DS1 of the wavelength dispersion amount and the distance L2 of the optical transmission line 3b in accordance with the wavelength λ2 (C-band) as a wavelength dispersion amount-M42 after the compensation in the optical relay apparatus 200c. The control apparatus 100 obtains a wavelength dispersion amount M52 accumulated up to the center of the optical transmission line 3c using the inclination DS2 of the wavelength dispersion amount in accordance with the wavelength λ3 (L-band) and half a distance L3/2 of the optical transmission line 3c, and obtains an optimal wavelength dispersion compensation amount M50 (=M51+M52) compensated by the optical relay apparatus 200d. The control apparatus 100 sets, in the optical relay apparatus 200d, an additional wavelength dispersion compensation amount M54 (=M50−M53) in the optical relay apparatus 200d from the optimal wavelength dispersion compensation amount M50 and a phase conjugation compensation amount M53 (=M51×2) compensated by phase conjugation.

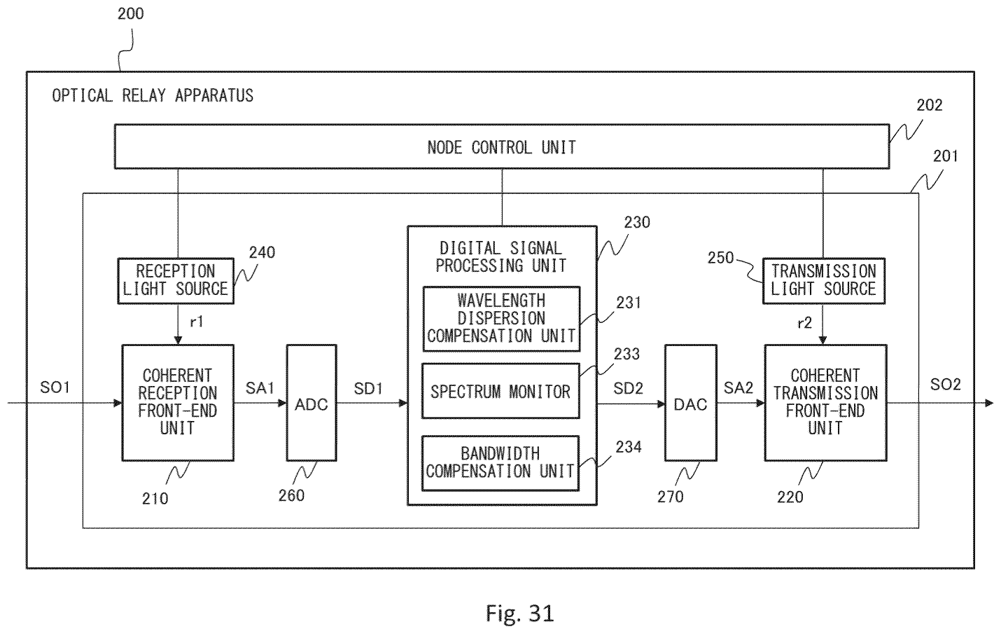

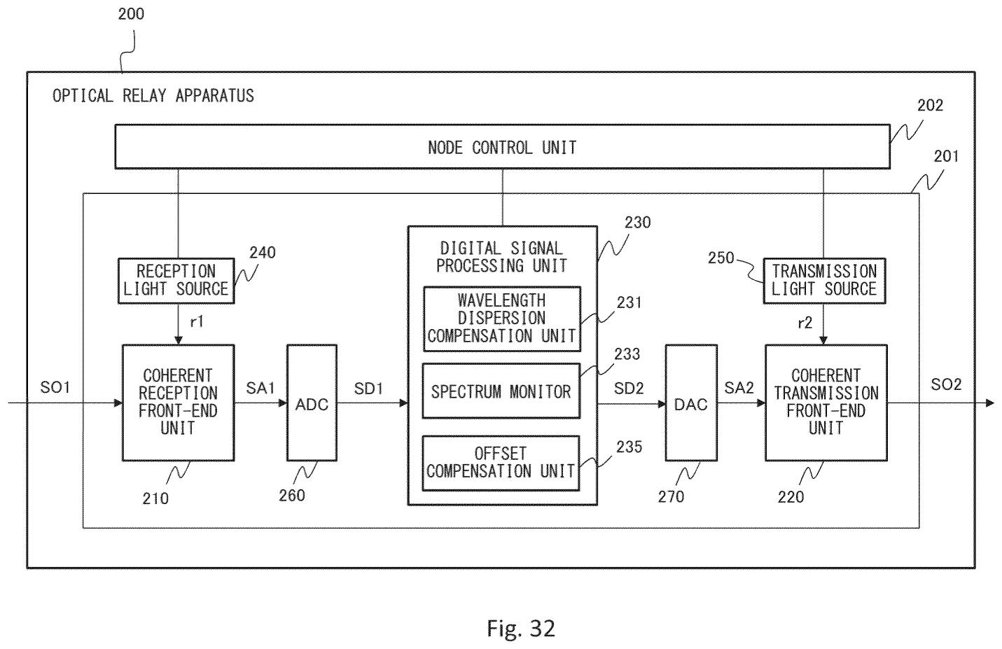

Further, the processing performed in the digital signal processing unit of the optical relay apparatus shown in the first to fourth example embodiments is not limited to wavelength dispersion compensation, and other signal quality compensation processing may be performed therein. For example, as shown in FIGS. 31 and 32, bandwidth compensation processing for compensating for signal band deterioration, frequency offset compensation processing for compensating for frequency deviation of a light source (local oscillation light) or the like may be performed.

In the example shown in FIG. 31, a digital signal processing unit 230 of an optical relay apparatus 200 includes, besides a wavelength dispersion compensation unit 231, a spectrum monitor 233 and a bandwidth compensation unit 234. The spectrum monitor 233 monitors a spectrum of a digital signal SD1 after wavelength dispersion compensation. The bandwidth compensation unit 234 performs bandwidth compensation on the digital signal SD1 after the wavelength dispersion compensation by increasing a signal level of a band that has been deteriorated in accordance with band deterioration of a spectrum that has been monitored. The bandwidth compensation unit 234 may be formed of a digital filter such as an FIR filter. Accordingly, it is possible to restore the narrowed signal band and suppress deterioration of the signal quality, such as band deterioration due to passage through an optical relay apparatus including an optical filter or band deterioration due to an optical transmission/reception analog front-end unit. As a matter of course, the wavelength dispersion compensation performed by the wavelength dispersion compensation unit 231 or the bandwidth compensation performed by the bandwidth compensation unit 234 may be collectively performed by a single FIR filter or a frequency domain equalization filter (FDE).

In the example shown in FIG. 32, a digital signal processing unit 230 of an optical relay apparatus 200 includes, besides a wavelength dispersion compensation unit 231, a spectrum monitor 233 and an offset compensation unit 235. The spectrum monitor 233 monitors a spectrum of a digital signal SD1 after wavelength dispersion compensation. The offset compensation unit 235 performs frequency offset compensation by shifting a frequency so as to correct a deviation of the frequency of the digital signal SD1 after the wavelength dispersion compensation in accordance with the frequency offset (wavelength deviation) of the monitored spectrum. The offset compensation unit 235 may be composed of a digital frequency shifter. Accordingly, it is possible to compensate for the frequency offset of the light source accumulated by multi-stage wavelength conversion inside the optical relay apparatus, and to suppress signal quality deterioration which is due to the frequency offset even in a case where multi-stage relay is configured.

Note that the present disclosure is not limited to the above-described example embodiments and may be changed as appropriate without departing from the spirit of the present disclosure.

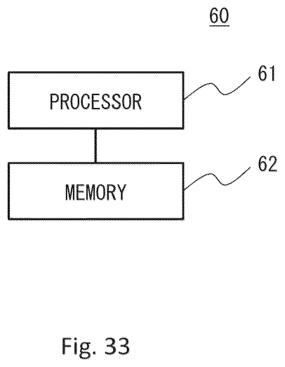

Each component according to the foregoing example embodiments is constituted by hardware or software or both. Each component may be constituted by one piece of hardware or software or by a plurality of pieces of hardware or software. Each apparatus (control apparatus and so on) and each function (process) may be implemented by a computer 60 including a processor 61 such as a Central Processing Unit (CPU) and a memory 62 serving as a storage apparatus, as shown in FIG. 33. For example, a program for performing a method (a control method and the like) according to the example embodiments may be stored in the memory 62, and each function may be implemented by the processor 61 executing the program stored in the memory 62.

These programs include instructions (or software codes) that, when loaded into a computer, cause the computer to perform one or more of the functions described in the embodiments. The programs may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The programs may be transmitted on a transitory computer readable medium or a communication medium. By way of example, and not a limitation, transitory computer readable media or communication media can include electrical, optical, acoustical, or other forms of propagated signals.

While the present disclosure has been described with reference to the example embodiments, the present disclosure is not limited to the aforementioned example embodiments. Various changes that may be understood by one skilled in the art may be made to the configurations and the details of the present disclosure within the scope of the present disclosure.

The whole or part of the example embodiments disclosed above can be described as, but not limited to, the following supplementary notes.

### Supplementary Note 1

An optical network system comprising an optical relay apparatus that forms an optical network and a control apparatus that controls the optical relay apparatus, wherein
the control apparatus comprises:
   management means for managing wavelength information of an optical signal transmitted and received by the optical relay apparatus in a path of the optical network and transmission line information of an optical transmission line connected to the optical relay apparatus; and
   compensation control means for determining a wavelength dispersion compensation amount compensated in the optical relay apparatus based on the wavelength information and the transmission line information, and
the optical relay apparatus comprises:
   acquisition means for acquiring the determined wavelength dispersion compensation amount from the control apparatus; and
   wavelength dispersion compensation means for performing, based on the acquired wavelength dispersion compensation amount, wavelength dispersion compensation processing on an electric signal which is based on an optical signal to be received.

### Supplementary Note 2

The optical network system according to Supplementary Note 1, wherein the compensation control means determines the wavelength dispersion compensation amount based on a wavelength dispersion amount accumulated in an optical transmission line on a reception side of the optical relay apparatus and a wavelength dispersion amount accumulated in an optical transmission line on a transmission side of the optical relay apparatus.

### Supplementary Note 3

The optical network system according to Supplementary Note 2, wherein the compensation control means obtains the wavelength dispersion amount accumulated in the optical transmission line on the reception side of the optical relay apparatus based on the wavelength information and the transmission line information on the reception side of the optical relay apparatus, and obtains the wavelength dispersion amount accumulated in the optical transmission line on the transmission side of the optical relay apparatus based on the wavelength information and the transmission line information on the transmission side of the optical relay apparatus.

### Supplementary Note 4

The optical network system according to Supplementary Note 2 or 3, wherein the compensation control means specifies wavelength dispersion characteristics of the optical transmission line based on the wavelength information, and obtains the wavelength dispersion amount accumulated in the optical transmission line based on the wavelength dispersion characteristics and a distance included in the transmission line information.

### Supplementary Note 5

The optical network system according to any one of Supplementary Notes 2 to 4, wherein the compensation control means determines the wavelength dispersion compensation amount based on a wavelength dispersion amount accumulated between a transmission end station apparatus in the path and the optical relay apparatus.

### Supplementary Note 6

The optical network system according to any one of Supplementary Notes 2 to 5, wherein the compensation control means determines the wavelength dispersion compensation amount based on a wavelength dispersion amount accumulated between the optical relay apparatus and a reception end station apparatus in the path.

### Supplementary Note 7

The optical network system according to Supplementary Note 6, wherein the wavelength dispersion compensation amount is a compensation amount which is based on a wavelength dispersion amount in the reception end station apparatus.

### Supplementary Note 8

The optical network system according to Supplementary Note 7, wherein the wavelength dispersion compensation amount is a compensation amount obtained under a condition that a wavelength dispersion amount in the reception end station apparatus becomes smaller than a predetermined value.

### Supplementary Note 9

The optical network system according to Supplementary Note 6, wherein the wavelength dispersion compensation amount is a compensation amount which is based on a predetermined wavelength dispersion amount range determined in advance in an optical transmission line from the optical relay apparatus to the reception end station apparatus.

### Supplementary Note 10

The optical network system according to Supplementary Note 9, wherein the wavelength dispersion compensation amount is a compensation amount obtained under a condition that the predetermined wavelength dispersion amount range becomes smaller than a predetermined value.

### Supplementary Note 11

The optical network system according to Supplementary Note 9 or 10, wherein the predetermined range is a range including the center of the optical transmission line.

### Supplementary Note 12

The optical network system according to Supplementary Note 6, wherein the wavelength dispersion compensation amount is a compensation amount which is based on an absolute value of a wavelength dispersion amount at each point from the optical relay apparatus to the reception end station apparatus.

### Supplementary Note 13

The optical network system according to Supplementary Note 12, wherein the wavelength dispersion compensation amount is a compensation amount obtained under a condition that the absolute value of the wavelength dispersion amount at each point from the optical relay apparatus to the reception end station apparatus becomes smaller than a predetermined value.

### Supplementary Note 14

The optical network system according to any one of Supplementary Notes 6 to 13, wherein the compensation control means acquires signal quality information of the optical signal received in the reception end station apparatus and determines the wavelength dispersion compensation amount based on the acquired signal quality information.

### Supplementary Note 15

The optical network system according to any one of Supplementary Notes 1 to 14, wherein the optical relay apparatus further comprises phase conjugation means for performing phase conjugation processing on an electric signal which is based on the received optical signal, and the compensation control means determines the wavelength dispersion compensation amount in the optical relay apparatus based on the wavelength dispersion compensation amount obtained by the phase conjugation processing.

### Supplementary Note 16

The optical network system according to Supplementary Note 15, wherein the compensation control means obtains the wavelength dispersion compensation amount by the phase conjugation processing based on the wavelength dispersion amount accumulated in the optical transmission line on the reception side of the optical relay apparatus.

### Supplementary Note 17

The optical network system according to any one of Supplementary Notes 1 to 16, wherein the compensation control means determines a wavelength dispersion compensation amount in a plurality of optical relay apparatuses that form the path based on the wavelength information and the transmission line information in the path.

### Supplementary Note 18

A control apparatus comprising:
management means for managing wavelength information on an optical signal transmitted and received by an optical relay apparatus in a path of an optical network and transmission line information of an optical transmission line connected to the optical relay apparatus; and
compensation control means for determining a wavelength dispersion compensation amount compensated in the optical relay apparatus based on the wavelength information and the transmission line information.

### Supplementary Note 19

The control apparatus according to Supplementary Note 18, wherein the compensation control means determines the wavelength dispersion compensation amount based on a wavelength dispersion amount accumulated in an optical transmission line on a reception side of the optical relay apparatus and a wavelength dispersion amount accumulated in an optical transmission line on a transmission side of the optical relay apparatus.

### Supplementary Note 20

An optical relay apparatus comprising:
acquisition means for acquiring a wavelength dispersion compensation amount from a control apparatus;
coherent optical reception front-end means for coherently detecting, based on local oscillation light, an optical signal to be received to output the coherently-detected electric signal;
wavelength dispersion compensation means for performing, based on the acquired wavelength dispersion compensation amount, wavelength dispersion compensation processing on the electric signal by digital signal processing; and
coherent optical transmission front-end means for coherently modulating, based on a transmission signal, the electric signal on which the wavelength dispersion compensation processing has been performed and transmitting the coherently-modulated optical signal.

### Supplementary Note 21

The optical relay apparatus according to Supplementary Note 20, further comprising phase conjugation means for performing phase conjugation processing on the electric signal by digital signal processing.

### Supplementary Note 22

The optical relay apparatus according to Supplementary Note 20 or 21, further comprising bandwidth compensation means for performing bandwidth compensation processing on the electric signal by digital signal processing.

### Supplementary Note 23

The optical relay apparatus according to any one of Supplementary Notes 20 to 22, further comprising offset compensation means for performing frequency offset compensation processing on the electric signal by digital signal processing.

### Supplementary Note 24

The optical relay apparatus according to any one of Supplementary Notes to 23, wherein the acquisition means acquires, from the control apparatus, reception wavelength information, which is information on a wavelength of the received optical signal, and transmission wavelength information, which is information on a wavelength of the optical signal to be transmitted, sets the wavelength of the reception wavelength information in a light source of the local oscillation light, and sets a wavelength of the transmission wavelength information in a light source of the transmission light.

### Supplementary Note 25

A control method comprising:
managing wavelength information on an optical signal transmitted and received by an optical relay apparatus in a path of an optical network and transmission line information of an optical transmission line connected to the optical relay apparatus; and
determining a wavelength dispersion compensation amount compensated in the optical relay apparatus based on the wavelength information and the transmission line information.

### Supplementary Note 26

The control method according to Supplementary Note 25, comprising determining the wavelength dispersion compensation amount based on a wavelength dispersion amount accumulated in an optical transmission line on a reception side of the optical relay apparatus and a wavelength dispersion amount accumulated in an optical transmission line on a transmission side of the optical relay apparatus.

### Supplementary Note 27

A non-transitory computer readable medium storing a control program for causing a computer to execute processing of:
managing wavelength information on an optical signal transmitted and received by an optical relay apparatus in a path of an optical network and transmission line information of an optical transmission line connected to the optical relay apparatus; and
determining a wavelength dispersion compensation amount compensated in the optical relay apparatus based on the wavelength information and the transmission line information.

### Supplementary Note 28

The non-transitory computer readable medium according to Supplementary Note 27, comprising determining the wavelength dispersion compensation amount based on a wavelength dispersion amount accumulated in an optical transmission line on a reception side of the optical relay apparatus and a wavelength dispersion amount accumulated in an optical transmission line on a transmission side of the optical relay apparatus.

### REFERENCE SIGNS LIST

1 OPTICAL NETWORK SYSTEM
2 OPTICAL RELAY APPARATUS
3 OPTICAL TRANSMISSION LINE
4, 5 DATA CENTER
6 IT SERVICE PROVIDER
7, 8 EVENT VENUE
10 CONTROL APPARATUS
11 MANAGEMENT UNIT
12 COMPENSATION CONTROL UNIT
20 OPTICAL RELAY APPARATUS
21 COHERENT RECEPTION FRONT-END UNIT
22 WAVELENGTH DISPERSION COMPENSATION UNIT
23 COHERENT TRANSMISSION FRONT-END UNIT
24 ACQUISITION UNIT
30 TRANSMITTING END STATION APPARATUS
40 RECEPTION END STATION APPARATUS
41 MONITORING UNIT
50 OPTICAL NETWORK SYSTEM
51 OPTICAL NETWORK
60 COMPUTER
61 PROCESSOR
62 MEMORY
100 CONTROL APPARATUS
110 NETWORK MANAGEMENT UNIT
120 NETWORK CONTROL UNIT
130 PARAMETER CALCULATION UNIT
140 PARAMETER VARIABLE UNIT
200 OPTICAL RELAY APPARATUS
201 OPTICAL TRANSCEIVER
202 NODE CONTROL UNIT
210 COHERENT RECEPTION FRONT-END UNIT
220 COHERENT TRANSMISSION FRONT-END UNIT
230 DIGITAL SIGNAL PROCESSING UNIT
231 WAVELENGTH DISPERSION COMPENSATION UNIT
232 PHASE CONJUGATION UNIT
233 SPECTRUM MONITOR
234 BANDWIDTH COMPENSATION UNIT
235 OFFSET COMPENSATION UNIT
240 RECEPTION LIGHT SOURCE
250 TRANSMISSION LIGHT SOURCE
260 ADC
270 DAC
300 OPTICAL SWITCH UNIT
301 DEMULTIPLEXER
302 MULTIPLEXER
303 BRANCH INSERTION UNIT
310 TRANSMISSION/RECEPTION UNIT
311, 312, 313, 314 OPTICAL TRANSCEIVER
401 DELAY DEVICE
402 MULTIPLIER
403 ADDER
411 OVERLAP ADDITION UNIT
412 FAST FOURIER TRANSFORM UNIT
413 INVERSE TRANSFER FUNCTION MULTIPLEXING UNIT
414 INVERSE FAST FOURIER TRANSFORM UNIT
415 OVERLAP REMOVAL UNIT

What is claimed is:

1. An optical network system comprising an optical relay apparatus that forms an optical network and a control apparatus that controls the optical relay apparatus, wherein
the control apparatus comprises:
a first memory storing instructions, and
a first processor configured to execute the instructions stored in the first memory to;
manage wavelength information of an optical signal transmitted and received by the optical relay apparatus in a path of the optical network and transmission line information of an optical transmission line connected to the optical relay apparatus; and
determine a wavelength dispersion compensation amount compensated in the optical relay apparatus based on the wavelength information and the transmission line information, and
the optical relay apparatus comprises:
a second memory storing instructions, and
a second processor configured to execute the instructions stored in the second memory to;
acquire the determined wavelength dispersion compensation amount from the control apparatus; and
perform, based on the acquired wavelength dispersion compensation amount, wavelength dispersion compensation processing on an electric signal which is based on an optical signal to be received.

2. The optical network system according to claim 1, wherein the first processor is further configured to execute the instructions stored in the first memory to determine the wavelength dispersion compensation amount based on a wavelength dispersion amount accumulated in an optical transmission line on a reception side of the optical relay apparatus and a wavelength dispersion amount accumulated in an optical transmission line on a transmission side of the optical relay apparatus.

3. The optical network system according to claim 2, wherein the first processor is further configured to execute the instructions stored in the first memory to obtain the wavelength dispersion amount accumulated in the optical transmission line on the reception side of the optical relay apparatus based on the wavelength information and the transmission line information on the reception side of the optical relay apparatus, and obtain the wavelength dispersion amount accumulated in the optical transmission line on the transmission side of the optical relay apparatus based on the wavelength information and the transmission line information on the transmission side of the optical relay apparatus.

4. The optical network system according to claim 2, wherein the first processor is further configured to execute the instructions stored in the first memory to specify wavelength dispersion characteristics of the optical transmission line based on the wavelength information, and obtain the wavelength dispersion amount accumulated in the optical transmission line based on the wavelength dispersion characteristics and a distance included in the transmission line information.

5. The optical network system according to claim 2, wherein the first processor is further configured to execute the instructions stored in the first memory to determine the wavelength dispersion compensation amount based on a wavelength dispersion amount accumulated between a transmission end station apparatus in the path and the optical relay apparatus.

6. The optical network system according to claim 2, wherein the first processor is further configured to execute the instructions stored in the first memory to determine the wavelength dispersion compensation amount based on a wavelength dispersion amount accumulated between the optical relay apparatus and a reception end station apparatus in the path.

7. The optical network system according to claim 6, wherein the wavelength dispersion compensation amount is a compensation amount which is based on a wavelength dispersion amount in the reception end station apparatus.

8. The optical network system according to claim 7, wherein the wavelength dispersion compensation amount is a compensation amount obtained under a condition that a wavelength dispersion amount in the reception end station apparatus becomes smaller than a predetermined value.

9. The optical network system according to claim 6, wherein the wavelength dispersion compensation amount is a compensation amount which is based on a predetermined wavelength dispersion amount range determined in advance in an optical transmission line from the optical relay apparatus to the reception end station apparatus.

10. The optical network system according to claim 9, wherein the wavelength dispersion compensation amount is a compensation amount obtained under a condition that the predetermined wavelength dispersion amount range becomes smaller than a predetermined value.

11. The optical network system according to claim 9, wherein the predetermined range is a range including the center of the optical transmission line.

12. The optical network system according to claim 6, wherein the wavelength dispersion compensation amount is a compensation amount which is based on an absolute value of a wavelength dispersion amount at each point from the optical relay apparatus to the reception end station apparatus.

13. The optical network system according to claim 12, wherein the wavelength dispersion compensation amount is a compensation amount obtained under a condition that the absolute value of the wavelength dispersion amount at each point from the optical relay apparatus to the reception end station apparatus becomes smaller than a predetermined value.

14. The optical network system according to claim 6, wherein the first processor is further configured to execute the instructions stored in the first memory to acquire signal quality information of the optical signal received in the reception end station apparatus and determine the wavelength dispersion compensation amount based on the acquired signal quality information.

15. The optical network system according to claim 1, wherein
the second processor is further configured to execute the instructions stored in the second memory to perform phase conjugation processing on an electric signal which is based on the received optical signal, and
the first processor is further configured to execute the instructions stored in the first memory to determine the wavelength dispersion compensation amount in the optical relay apparatus based on the wavelength dispersion compensation amount obtained by the phase conjugation processing.

16. The optical network system according to claim 15, wherein the first processor is further configured to execute the instructions stored in the first memory to obtain the wavelength dispersion compensation amount by the phase conjugation processing based on the wavelength dispersion amount accumulated in the optical transmission line on the reception side of the optical relay apparatus.

17. The optical network system according to claim 1, wherein the first processor is further configured to execute the instructions stored in the first memory to determine a wavelength dispersion compensation amount in a plurality of optical relay apparatuses that form the path based on the wavelength information and the transmission line information in the path.

18. A control apparatus comprising:
a memory storing instructions, and
a processor configured to execute the instructions stored in the memory to;
manage wavelength information on an optical signal transmitted and received by an optical relay apparatus in a path of an optical network and transmission line information of an optical transmission line connected to the optical relay apparatus; and
determine a wavelength dispersion compensation amount compensated in the optical relay apparatus based on the wavelength information and the transmission line information.

19. The control apparatus according to claim 18, wherein the processor is further configured to execute the instructions stored in the memory to determine the wavelength dispersion compensation amount based on a wavelength dispersion amount accumulated in an optical transmission line on a reception side of the optical relay apparatus and a wavelength dispersion amount accumulated in an optical transmission line on a transmission side of the optical relay apparatus.

20.-24. (canceled)

25. A control method comprising:
managing wavelength information on an optical signal transmitted and received by an optical relay apparatus in a path of an optical network and transmission line information of an optical transmission line connected to the optical relay apparatus; and
determining a wavelength dispersion compensation amount compensated in the optical relay apparatus based on the wavelength information and the transmission line information.

26.-28. (canceled)
